(19) United States
(12) Patent Application Publication
(10) Pub. No.: US 2024/0257830 A1
(43) Pub. Date: Aug. 1, 2024

(54) MAGNETIC HEAD WITH A MULTILAYER BETWEEN A MAIN POLE AND AN AUXILIARY POLE AND MAGNETIC RECORDING/REPRODUCING DEVICE

(71) Applicants: KABUSHIKI KAISHA TOSHIBA, Tokyo (JP); Toshiba Electronic Devices & Storage Corporation, Tokyo (JP)

(72) Inventor: Kaori KIMURA, Yokohama (JP)

(73) Assignees: Kabushiki Kaisha Toshiba, Tokyo (JP); Toshiba Electronic Devices & Storage Corporation, Tokyo (JP)

(21) Appl. No.: 18/634,025

(22) Filed: Apr. 12, 2024

Related U.S. Application Data
(62) Division of application No. 18/114,879, filed on Feb. 27, 2023.

(30) Foreign Application Priority Data
Aug. 16, 2022 (JP) 2022-129603

(51) Int. Cl. G11B 5/127; G11B 5/00

(52) U.S. Cl. CPC G11B 5/1278; G11B 2005/0024

(57) ABSTRACT

According to one embodiment, a magnetic head comprises a main pole, an auxiliary magnetic pole provided with the main pole with a write gap therebetween, and a multi-layer provided between the main pole and the auxiliary magnetic pole, by which electric conductivity is enabled from the main pole to the auxiliary magnetic pole. The multi-layer includes a first cooling layer and a first conductive layer, orderly provided on a surface of the main pole opposed to the auxiliary magnetic pole, and the first cooling layer cools the main pole by Peltier effect when electric current is applied, and a length thereof in a track width is longer than a length in a track width of the main pole.

### CROSS-REFERENCE TO RELATED APPLICATIONS

This application is based upon and claims the benefit of priority from Japanese Patent Application No. 2022-129603, filed Aug. 16, 2022, the entire contents of which are incorporated herein by reference.

### FIELD

Embodiments described herein relate generally to a magnetic head, and a magnetic recording/reproducing device.

### BACKGROUND

In order to improve recording density of hard disk drives (HDDs), magnetic recording heads using assisted recording methods have been proposed. Assisted recording methods include, for example, microwave-assisted magnetic recording (MAMR), heat-assisted magnetic recording (HAMR), or energy-assisted perpendicular magnetic recording.

For example, in the case of high-frequency assist technology, a large current flows through the spin torque oscillator (STO) between main and auxiliary magnetic poles of the high-frequency assist head, which causes oxidation of the STO due to Joule heating. The greatest amount of heat generation occurs in the STO with the highest current density, but because the STO is a multi-layer metal film, it is considered that the Peltier effect will occur simultaneously, resulting in the transport of heat. As a result, in the structure of conventional high-frequency assist heads, it is the area near the main pole rather than the STO that is most affected by the resulting heat, and the oxidation of the main pole tends to precede the STO. Since the oxidation of the main pole is directly related to the deterioration of BER (bit error rate), it is desirable to suppress such oxidation.

### BRIEF DESCRIPTION OF THE DRAWINGS

FIG. 1 illustrates a structure of a magnetic head of an embodiment, viewed from an ABS side.

FIG. 2 is a model diagram illustrating Peltier effect.

FIG. 3 illustrates a structure of a magnetic recording/reproducing device of the embodiment.

FIG. 4 is a side view illustrating a magnetic head and a suspension.

FIG. 5 is a cross-sectional view illustrating a head part of the magnetic head and a magnetic disk, in an enlarged manner.

FIG. 6 is a schematic perspective view illustrating a recording head and the magnetic disk.

FIG. 7 is a cross-sectional view illustrating an end of the recording head in the magnetic disk side, taken along a track center in an enlarged manner.

FIG. 8 illustrates the example of FIG. 7, viewed from the ABS side.

FIG. 9 is a cross-sectional view illustrating an end of the recording head in the magnetic disk side, taken along a track center in an enlarged manner.

FIG. 10 is a schematic view if magnetization state within a write gap WG.

FIG. 11 is a cross-sectional view illustrating another example of the structure of the magnetic head.

FIG. 12 is a cross-sectional view of the recording head of FIG. 11, taken along a track center.

FIG. 13 is a cross-sectional view illustrating another example of the structure of the magnetic head.

FIG. 14 is a cross-sectional view of the recording head of FIG. 13, taken along a track center.

FIG. 15 is a cross-sectional view illustrating another example of the structure of the magnetic head.

FIG. 16 illustrates another example of the magnetic head of the embodiment, viewed from the ABS side.

FIG. 17 is a cross-sectional view of the recording head of FIG. 16, taken along a track center.

FIG. 18 illustrates yet another example of the magnetic head of the embodiment, viewed from the ABS side.

FIG. 19 illustrates yet another example of the magnetic head of the embodiment, viewed from the ABS side.

FIG. 20 illustrates yet another example of the magnetic head of the embodiment, viewed from the ABS side.

FIG. 21 is a cross-sectional view of the recording head of FIG. 20, taken along a track center.

FIG. 22 illustrates yet another example of the magnetic head of the embodiment, viewed from the ABS side.

FIG. 23 illustrates yet another example of the magnetic head of the embodiment, viewed from the ABS side.

### DETAILED DESCRIPTION

In general, according to one embodiment, a magnetic head includes: a main pole configured to apply a recording magnetic field to a magnetic recording medium; an auxiliary magnetic pole provided with the main pole with a write gap therebetween, forming a magnetic circuit with the main pole; and a multi-layer provided between the main pole and the auxiliary magnetic pole, by which electric conductivity is enabled from the main pole to the auxiliary magnetic pol. The multi-layer includes a first cooling layer and a first conductive layer, orderly provided on a surface of the main pole opposed to the auxiliary magnetic pole, and the first cooling layer cools the main pole by Peltier effect when electric current is applied. A length thereof in a track width is longer than a length in a track width of the main pole.

Furthermore, according to another embodiment, a magnetic recording/reproducing device includes a magnetic head. The magnetic head includes: a main pole configured to apply a recording magnetic field to a magnetic recording medium; an auxiliary magnetic pole provided with the main pole with a write gap therebetween, forming a magnetic circuit with the main pole; and a multi-layer provided between the main pole and the auxiliary magnetic pole, by which electric conductivity is enabled from the main pole to the auxiliary magnetic pole, wherein the multi-layer includes a first cooling layer and a first conductive layer, orderly provided on a surface of the main pole opposed to the auxiliary magnetic pole, and the first cooling layer cools the main pole by Peltier effect when electric current is applied, and a length thereof in a track width is longer than a length in a track width of the main pole.

Hereinafter, embodiments will be described with reference to the accompanying drawings.

The disclosure is merely an example and is not limited by contents described in the embodiments described below. Modification which is easily conceivable by a person of ordinary skill in the art comes within the scope of the disclosure as a matter of course. In order to make the description clearer, the sizes, shapes and the like of the respective parts may be changed and illustrated schematically in the drawings as compared with those in an accurate representation. Constituent elements corresponding to each other in a plurality of drawings are denoted by the same reference numerals and their detailed descriptions may be omitted unless necessary.

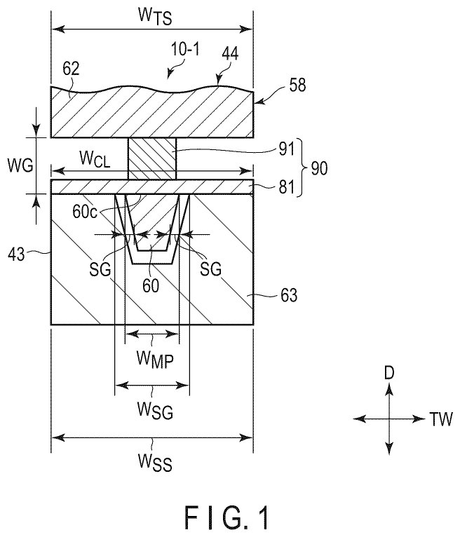

FIG. 1 illustrates a structure of a magnetic head as viewed from an ABS side.

As in the figure, a head part 44 of a magnetic head 10 includes a main pole 60 which applies a recording magnetic field to a magnetic recording medium, auxiliary magnetic pole 62 which is provided with the main pole 60 with a write gap WG therebetween such that a magnetic circuit is formed together with the main pole 60, and multi-layer 90 which is provided between the main pole 60 and the auxiliary magnetic pole 62 and is capable of energizing the auxiliary magnetic pole 62 from the main pole 60. The multi-layer 90 includes a first cooling layer 81 and a first conductive layer 91, which are provided in order on a surface 60c of the main pole 60 opposed to the auxiliary magnetic pole 62. The first cooling layer is provided with the side surface 60c of the main pole 60 in the auxiliary pole 62 side (trailing shield side end surface), and cools the main pole 60 by the Peltier effect when energized. Furthermore, a track width direction length W_{CL} of the first cooling layer 81 is longer than the track width direction length W_{MP} of the main pole 60. The track width direction length W_{CL} of the first cooling layer 81 may be equivalent to the track width direction length W_{SS} of the side shield 63. Furthermore, the cross-sectional area of the first cooling layer 81 perpendicular to the direction of current flow may be larger than the cross-sectional area of the main poles 60 perpendicular to the direction of current flow. The side shields 63 are arranged opposite to each other in both sides of the main pole 60 in the track width direction TW with a side gap SG therebetween. The side shield 63 and the auxiliary magnetic pole 62 can be formed integrally using a soft magnetic material.

According to the magnetic head of the embodiment, the first cooling layer 81 on the main pole 60 has a track width direction length W_{CL} longer than the track width direction length W_{MP} of the main pole 60 and can cool the main pole 60 by the Peltier effect at the interface between the first cooling layer 81 and the main pole 60 when energized, and thus, the main pole 60 and the first cooling layer 81 is structured in such a way that heat from the main pole 60 can escape to the outside. As a result, the direction of heat transport can be shifted from the main pole 60 side to the surrounding first conductive layer 91, auxiliary magnetic pole 62, and side shield 63, thereby suppressing heat generation at the main pole 60, suppressing deterioration of the recording/reproducing element due to oxidation of magnetic elements such as iron, and improving the recording/reproducing element life. In addition, if the track width direction length W_{CL} of the first cooling layer 81 is set to be equal to the track width direction length W_{SS} of the side shield 63, in addition to the above-mentioned effect of improving the recording/reproducing element life, the track width direction lengths of the side shield 63 and the first cooling layer 81 can be machined together in the manufacturing process of the magnetic head 10, which results in lower cost.

Furthermore, if the cross-sectional area of the first cooling layer 81 perpendicular to the direction of current flow is larger than the cross-sectional area of the main pole 60 perpendicular to the direction of current flow, the interface between the first cooling layer 81 and the main pole 60 can be sufficiently large, and heat can be transported more easily to the first conducting layer 91, auxiliary magnetic pole 62, and side shield 63 around the first cooling layer 81, and the main pole can be cooled down better, which can improve the recording/reproducing device life more effectively.

The first cooling layer 81 may be in contact with the main pole 60. A conductor having a composition different from that of the main pole 60 can be used as the material of the first cooling layer 81. When the first cooling layer 81 contacts the main pole 60, the material of the first cooling layer 81 can be selected with respect to the main pole 60 such that the first cooling layer 81 dissipates heat to the first cooling layer 81 according to the Peltier coefficient of the material of the main pole 60, that is, the first cooling layer 81 absorbs heat from the main pole 60.

As a conductor used in the first cooling layer 81, at least one non-magnetic conductor such as Al, Cr, Cu, Ir, Mn, Mo, Ni, Pd, Pt, Ru, Si, Ta, W, or Zn may be used. In addition, not only a single non-magnetic conductor, but also a compound such as Cu—Ni alloy or MnSiAl, for example, can be used as the material of the first cooling layer 81. Furthermore, the material of the first cooling layer 81 may contain a few percent of additives in the non-magnetic conductor, such as O in ZnAlO, for example.

The thickness of the first cooling layer 81 may be between 0.2 and 10 nm. If the thickness of the first cooling layer 81 is thicker than 10 nm, a distance between the main pole 60 and the assist magnetic field tends to open up, making it difficult to obtain an assist effect, and if the thickness is less than 0.2 nm, the material properties tend to deteriorate and sufficient cooling effect cannot be obtained.

The Peltier effect used in the embodiment refers to an effect of heat absorption or release when an electric current is applied to a joint surface of dissimilar materials.

The cooling layer of, for example, the first cooling layer 81 used in the embodiment can utilize the Peltier effect due to the stacked structure of two or more layers of mutually different conductors. For example, the amount of heat transferred by the Peltier effect at the interface between the first and second material layers, dQ₁₂ can be expressed by the following equation (1), using the Peltier coefficient π₁₂ of the interface between the layers of first and second material that are stacked.

$${dQ}_{12} = {π}_{12} I dt \qquad ( 1 )$$

where I is current and dt is time. The Peltier coefficient π₁₂₀f the interface between the two layers can be calculated from the Peltier coefficient π₁ of the first material and the Peltier coefficient π₂ of the second material using the following equation (2).

$${π}_{12} = {π}_{2} - {π}_{1} \qquad ( 2 )$$

To achieve the desired Peltier effect, a second material with a Peltier coefficient can be selected which will either absorb or dissipate heat, depending on the Peltier coefficient of the first material.

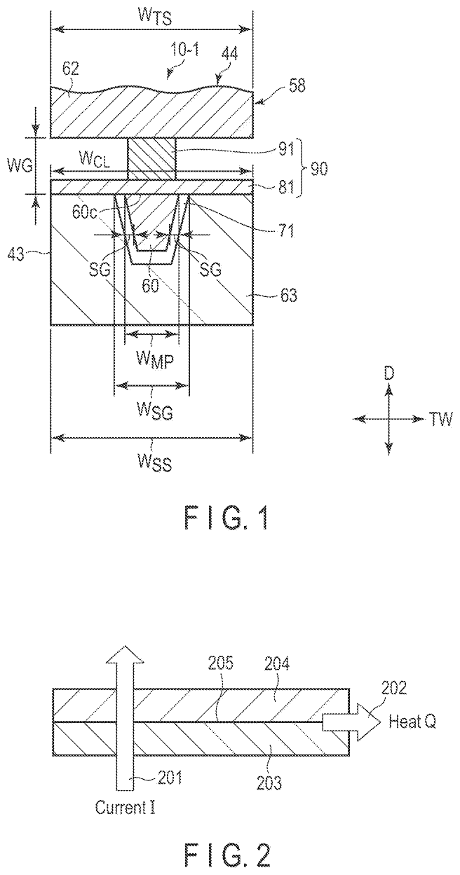

FIG. 2 is a model diagram illustrating the Peltier effect at the interface of different material layers.

As in the figure, for example, when a layer 203 of the first material is the first cooling layer and a layer 204 of the second material, which is different from the first material, is the main pole, and the layers 203 and 204 have a bonded structure, and the respective Peltier coefficients are π₁ and π_{MP}, then the Peltier coefficient π_{1MP} of the interface 205 of layers 203 and 204 of the first and second materials is π_{MP}−π₁. When the current flows from the first cooling layer 203 to the main pole 204 as shown by arrow 201, when π_{1MP}>0, that is, when π₁<π_{MP}, heat absorption occurs at the interface 205 and the main pole 204 is cooled. On the other hand, when the direction of current flow is opposite to the arrow 201 and flows from the main pole 204 to the first cooling layer 203, when π₁>π_{MP}, heat absorption occurs at the interface 205 and the main pole 204 is cooled.

As above, the material of the first cooling layer 203 can be selected to be heat absorbing or heat dissipating, depending on the direction of the current and the Peltier coefficient of the main pole 204.

The first cooling layer may be one or two or more multilayers. Even when the first cooling layer has two or more multilayers, heat absorption basically occurs at the interface when the Peltier coefficient of the first cooling layer is larger than the Peltier coefficient π_{MP} of the main pole.

For example, if the first cooling layer is two layers with the first layer on the main pole and the second layer on the first layer, and the current flows from the trailing shield (auxiliary magnetic pole) through the flux control layer to the main pole, and if the Peltier coefficient of the first layer is π₁, Peltier coefficient of the second layer is π₂, Peltier coefficient of the main pole is π_{MP}, Peltier coefficient of the interface between the first layer and the main pole is π_{1MP}, and Peltier coefficient of the interface between the first layer and the second layer is π₂₁, and if π_{1MP}>0, that is, π₁<π_{MP}, heat absorption occurs at the interface between the first layer and the main pole, and if π₂₁<0, that is, π₂<π₁, heat radiation occurs at the interface between the first layer and the second layer, and the heat absorption and heat dissipation are effectively performed by the temperature difference between the two interfaces. On the other hand, when the direction of the current is opposite, if the direction of the inequality of the Peltier coefficient is opposite, i.e., π_{1MP}<0, i.e., π₁>π_{MP}, heat absorption occurs at the interface between the first layer and the main pole, and if π₂₁>0, i.e., π₂>π₁, heat dissipation occurs at the interface between the first and second layers.

Depending on the direction of the current and the Peltier coefficient of the main pole, the materials of the layers of the first cooling layer can be selected respectively such that, when the first cooling layer has one layer, heat absorption at the interface with the main pole is used, and when there are two or more layers, heat dissipation at the interface between the first and second layers and heat absorption at the interface with the main pole are used.

Furthermore, if the first cooling layer is a multi-layer of x layers (x is 2 or more), the layers closer to the main pole side are orderly referred to as first layer, . . . , x−1 layer, and x layer, and where the Peltier coefficient of the main pole is π_{MP} and the Peltier coefficients of each layer of the first cooling layer is π₁, . . . , π_{X-1}, and π_{X}, and the current flow direction is from the trailing shield, the first cooling layer, and the main pole in that order, π_{MP}>π₁ and π_{X-1}<π_{X}, heat absorption occurs at the interface between the first cooling layer and the main pole and a cooling effect on the main pole is obtained. The material of the first cooling layer satisfying π_{MP}>π₁ is, for example, anon-magnetic conductor with a smaller Peltier coefficient than, for example, FeCo, which constitutes the main pole, such as Ta, Pd, or CuNi alloy. On the other hand, when the current flow direction is in the order of the main pole, the first cooling layer, and the trailing shield, if π_{MP}<π₁ and π_{X-1}>π_{X}, heat absorption occurs at the interface between the first cooling layer and the main pole, and a cooling effect of the main pole is obtained. The material of the first cooling layer satisfying π_{MP}<π₁ is, for example, a non-magnetic conductor with a smaller Peltier coefficient than, for example, FeCo, which constitutes the main pole, such as Cr, Mo, and W.

When the first cooling layer is a multilayer of x layers, the cooling effect can be enhanced by having heat absorption and heat dissipation occur at the respective interfaces. For example, if the first cooling layer has a structure of two or more layers, heat absorption and heat dissipation can be generated between the main pole side of the first cooling layer and another layer in the first cooling layer.

For example, when the direction of current flow is from trailing shield to the cooling layer, and to the main pole, π_{MP}>π₁ and π_{X-1}<π_{X}, heat absorption can be generated between the main pole and the first layer, and heat dissipation between x−1 layer and x layer. For example, since the Peltier coefficient decreases in the order of CuNi alloy, Ni, FeCo alloy, Ta, Au, Pt, Ru, and Ti, the first cooling layer can be selected as appropriate, such as Ru for the first cooling layer, Ta for the x−1 cooling layer, and Ni for the x cooling layer to satisfy π_{X-1}<π_{X}. By using such an arrangement, heat absorption can occur between the main pole and the first cooling layer, and heat dissipation can occur between the x−1 cooling layer and the x cooling layer. By generating heat absorption and heat dissipation simultaneously, the cooling effect can be enhanced.

For example, when the direction of current flow is from the main pole, to the cooling layer, and to the trailing shield, π_{MP}<π₁ and π_{X-1}>π_{X}, heat absorption can be generated between the main pole and the first layer, and heat dissipation between the x−1 layer and x layer. For example, the first cooling layer can be selected as appropriate, such as CuNi alloy, Pd for the x−1 cooling layer, and Ru for the x cooling layer. This arrangement allows heat absorption between the main pole and the first cooling layer and heat dissipation between the x−1 cooling layer and the x cooling layer, even when the direction of current flow is changed.

From the viewpoint of heat dissipation effect during cooling, the track width direction length W_{CL} of the first cooling layer can be wider than the track width direction length W_{MP} of the main pole 60. The width W_{CL} of the first cooling layer is preferably thicker than or equal to the track width direction length W_{SG} of the gap in the side shield 63 surrounding the main pole 60, and it is even more preferably greater than five times the track width direction length W_{MP} of the main pole 60. More preferably, the track width direction length W_{CL} of the first cooling layer can be equal to the track widthwise TW length W_{SS} of the side shield 63.

As the first conductive layer 91, for example, a write assist element or a non-magnetic conductive layer can be used.

Write assist elements such as a magnetic flux control layer with the ability to oscillate spin torque for microwave-assisted magnetic recording can be used. Nonmagnetic conductive layers may also be used for energy-assisted perpendicular magnetic recording. Such non-magnetic conductive layers can be used for perpendicular magnetic recording by assisting magnetization reversal by generating a magnetic field due to the concentration of current when energizing the main poles.

The thickness of the non-magnetic conductive layer can be 2 to 20 nm, similar to the thickness of the magnetic flux control layer.

Al, Cr, Cu, Ir, Mo, Ni, Pd, Pt, Ru, Si, Ta, and W can be used as materials for the non-magnetic conducting layer.

The first conductive layer 91 may be in contact with the first cooling layer 81. Alternatively, an intermediate layer, which is not shown, can be provided between the first cooling layer 81 and the first conductive layer 91, for example, to control orientation. The same material as the non-magnetic conductive layer can be used as the intermediate layer.

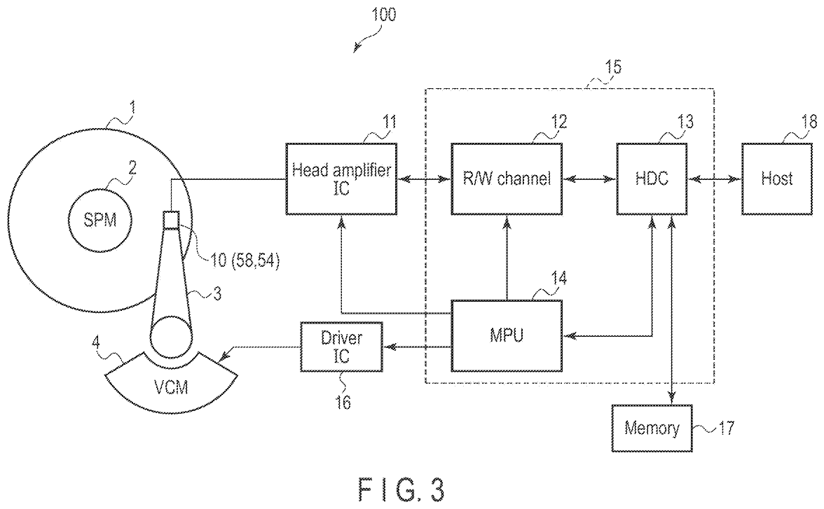

Next, the structure of the disk drive related to the present embodiment is described with reference to FIG. 3. The structure of the disk drive shown in FIG. 3, which is a magnetic recording/reproducing device, is also applicable to each of the embodiments described below.

As in FIG. 3, a disk drive 100 is a perpendicular magnetic recording magnetic disk device which incorporates a magnetic disk (hereinafter simply referred to as disk) 1, which is a perpendicular magnetic recording medium, and a magnetic head 10 with a magnetic flux control layer, as described below.

The disk 1 is fixed to a spindle motor (SPM) 2 and mounted for rotational motion. The magnetic head 10 is mounted on an actuator 3 and is configured to move radially on the disk 1. The actuator 3 is driven rotationally by a voice coil motor (VCM) 4. The magnetic head 10 has a record (write) head 58 and a reproducing (read) head 54.

In addition, the disk drive includes a head amplifier integrated circuit (hereinafter referred to as head amplifier IC) 11, read/write channel (R/W channel) 12, hard disk controller (HDC) 13, microprocessor (MPU) 14, driver IC 16, and memory 17. The R/W channel 12, HDC 13, and MPU 14 are incorporated in the controller 15, which includes a single-chip integrated circuit.

The head amplifier IC 11 includes a group of circuits for driving a spin-torque oscillator (STO), which is the magnetic flux control layer, as described below. The spin-torque oscillator will be hereinafter referred to as STO. Furthermore, the head amplifier IC 11 includes a driver which supplies recording signals (write current) to the recording head 58 in accordance with the write data supplied from the R/W channel 12. The head amplifier IC 11 also includes a read amplifier which amplifies the read signal output from the reproducing head 54 and transmits the signal to the R/W channel 12.

The R/W channel 12 is a signal processing circuit for read/write data. The HDC 13 includes the interface between the disk drive and the host 18 and performs read/write data transfer control.

The MPU 14 is the main control unit of the disk drive and executes servo control necessary for controlling read/write operations and positioning the magnetic head 10. In addition, the MPU 14 executes the energizing control of the STO related to the present embodiment. The memory 17 includes buffer memory consisting of DRAM and flash memory.

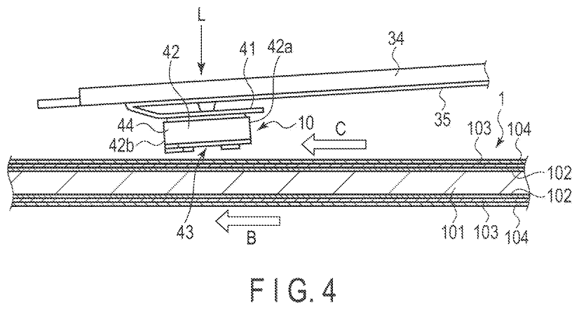

FIG. 4 is a side view of the magnetic head 10 and suspension.

As in FIG. 4, each magnetic head 10 is configured as a levitating head and has a substantially rectangular-shaped slider 42 and a head part 44 for recording/reproducing provided at the outflow end (trailing end) of this slider 42. The magnetic head 10 is fixed to a gimbal spring 41 provided at the end of the suspension 34. Each magnetic head 10 is subjected to a head load L toward the surface of the magnetic disk 1 due to the elasticity of the suspension 34. As shown in FIG. 4, each magnetic head 10 is connected to the head amplifier IC 11 and HDC 13 through the suspension 34 and the line member (flexure) 35 fixed on the arm 32.

Next, the structure of the magnetic disk 1 and magnetic head 10 will be described in detail.

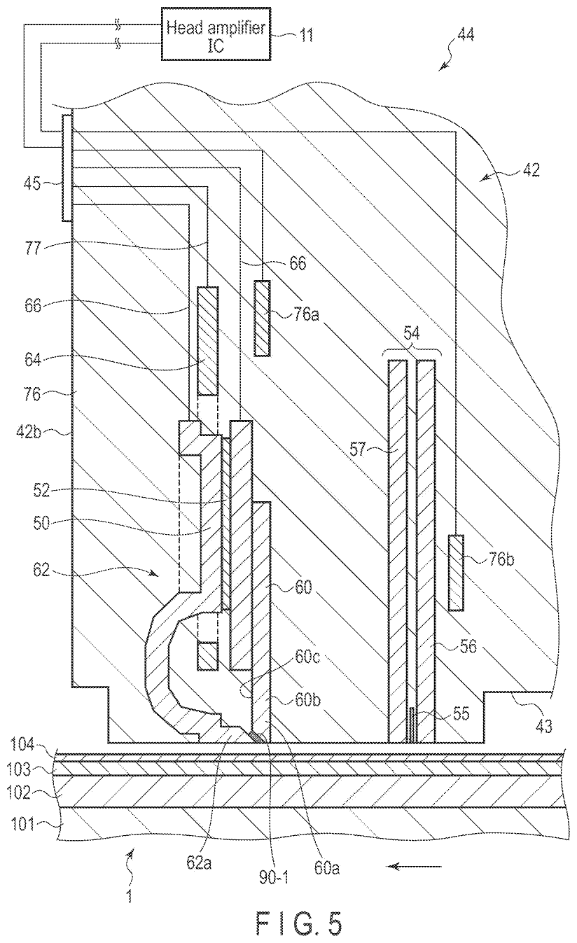

FIG. 5 is a cross-sectional view of the head part 44 of the magnetic head 10 and the magnetic disk 1, depicted in an enlarged manner.

As in FIGS. 4 and 5, the magnetic disk 1 includes a substrate 101, for example, formed in the shape of a disk about 2.5 inches (6.35 cm) in diameter and formed of a non-magnetic material. On each surface of the substrate 101, a soft magnetic layer 102 formed of a material exhibiting soft magnetic properties as a base layer, magnetic recording layer 103 having magnetic anisotropy perpendicular to the disk surface, and protective layer 104 are stacked in this order.

The slider 42 of the magnetic head 10 is formed of sintered alumina and titanium carbide (AlTiC), for example, and the head part 44 is formed by layering thin films. The slider 42 includes a rectangular disk-facing surface (air bearing surface (ABS)) 43 facing the surface of the magnetic disk 1. The slider 42 is levitated by the airflow C generated between the disk surface and the ABS 43 by the rotation of the magnetic disk 1. The direction of the airflow C coincides with the direction of rotation B of the magnetic disk 1. The slider 42 is positioned with respect to the surface of magnetic disk 1 such that the longitudinal direction of ABS 43 is substantially aligned with the direction of airflow C.

The slider 42 includes a leading end 42a located on the inflow side of airflow C and a trailing end 42b located on the outflow side of airflow C. The ABS 43 of the slider 42 includes a leading step, trailing step, side step, negative pressure cavity, etc., which are not shown.

As in FIG. 5, the head part 44 includes a reproducing head 54 and a recording head (magnetic recording head) 58 formed by a thin-film process on the trailing end 42b of the slider 42, forming a separate magnetic head. The reproducing head 54 and the recording head 58 are covered by a protective insulating film 76, except for the part exposed to the ABS 43 of the slider 42. The protective insulating film 76 forms the outline of the head part 44.

The reproducing head 54 includes a magnetic film 55 which exhibits a magnetoresistive effect and shield films 56 and 57 which are positioned to hold the magnetic film 55 on the trailing and leading sides of the magnetic film 55. The lower edges of the magnetic films 55 and shield films 56 and 57 are exposed to the ABS 43 of the slider 42. The recording head 58 is provided with the trailing end 42b side of the slider 42 relative to the reproducing head 54.

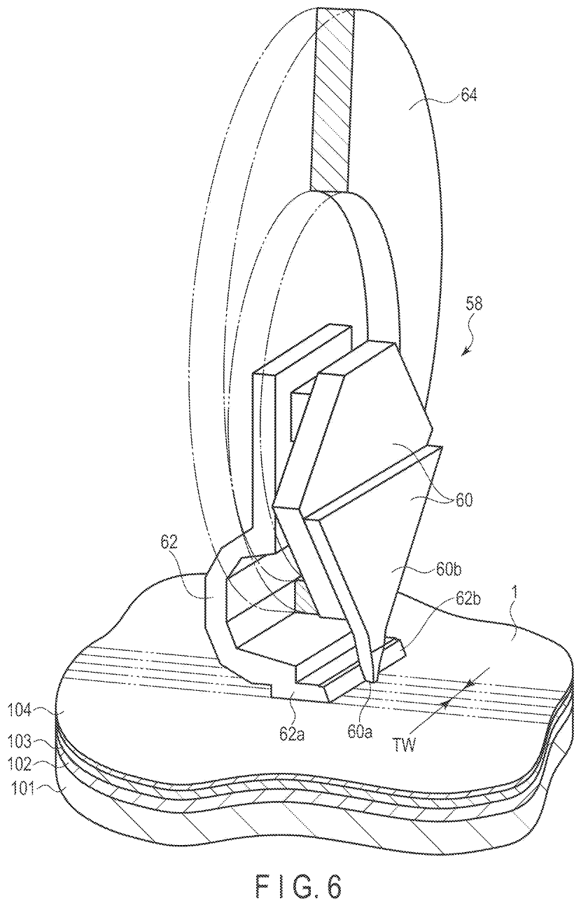

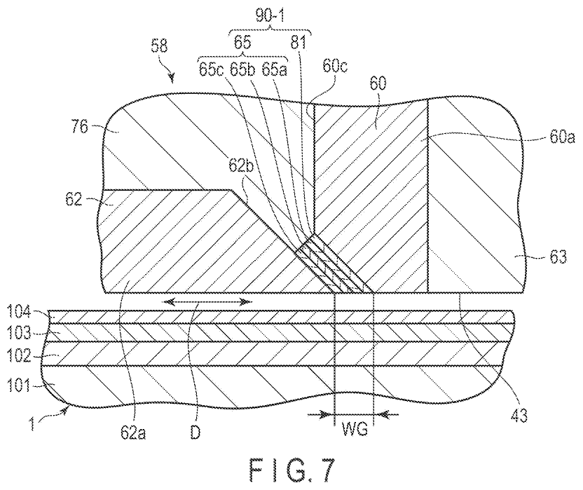

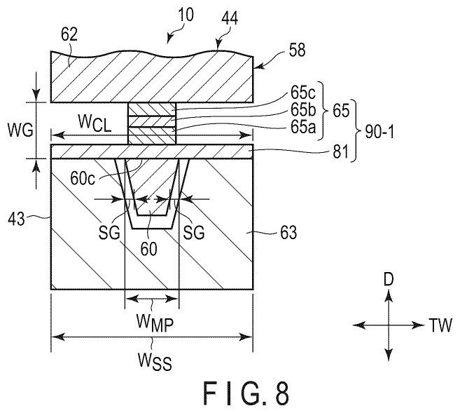

FIG. 6 is a schematic perspective view of the recording head 58 and the magnetic disk 1, and FIG. 7 is a cross-sectional view along the track center, illustrating the end of the recording head 58 on the magnetic disk 1 side in an enlarged manner. FIG. 8 illustrates FIG. 7, viewed from the ABS side. FIG. 8 is a cross-sectional view of a part of the recording head 58 of FIG. 7, in an enlarged manner.

As in FIGS. 5 to 8, the recording head 58 includes a main pole 60 formed of a highly saturated magnetizing material which generates a recording magnetic field perpendicular to the surface of the magnetic disk 1, trailing shield (auxiliary magnetic pole) 62 formed of a soft magnetic material, provided on the trailing side of the main pole 60 to effectively close the magnetic path through a soft magnetic layer 102 directly below the main pole 60, recording coil 64 provided to wrap around a magnetic core (magnetic circuit) which includes the main pole 60 and the trailing shield 62 to pass magnetic flux through the main pole 60 when writing signals to the magnetic disk 1, and a multi-layer 90-1 provided between the tip 60a of the main pole 60 on the ABS 43 side and the trailing shield 62, and flush with the ABS 43.

The multi-layer 90-1 is an example of the multi-layer 90 of FIG. 1, with a single-layer first cooling layer 81 on the main pole 60 which cools the main pole 60 by the Peltier effect when energized, and a flux control layer 65 as the first conducting layer on the first cooling layer 81.

The track width direction length W_{CL} of the first cooling layer 81 is longer than the track width direction length W_{MP} of the main pole 60. Here, the track width direction length W_{CL} of the first cooling layer 81 is equivalent to the track width direction length W_{SS} of the side shield 63. Furthermore, the cross-sectional area of the first cooling layer 81 perpendicular to the direction of current flow can be larger than the cross-sectional area of the main pole 60 perpendicular to the direction of current flow.

The cross-sectional area perpendicular to the direction of current flow of the main pole 60 is smaller than the cross-sectional area perpendicular to the direction of current flow of the flux control layer 65, and the length of the flux control layer 65 in the track width direction is shorter than the track width direction length W_{MP} of the main pole 60.

The main pole 60 formed of a soft magnetic material extends substantially perpendicular to the surface of the magnetic disk 1 and the ABS 43. The lower end of the main pole 60 on the ABS 43 side includes a narrowed portion 60b tapering toward the ABS 43 and narrowed in a funnel-like shape in the track width direction, and a tip 60a of a predetermined width extending from the narrowed portion 60b toward the magnetic disk. The tip, or lower end, of the tip 60a is exposed to the ABS 43 of the magnetic head. The width of the tip 60a in the track width direction corresponds approximately to the track width TW in the magnetic disk 1. The main pole 60 also has a trailing shield side end surface 60c, which extends approximately perpendicular to the ABS 43 and faces the trailing side. In one example, the end of the trailing shield side end surface 60c in the ABS 43 side extends inclined toward the trailing shield side with respect to the ABS 43.

The trailing shield 62 formed of a soft magnetic material is approximately L-shaped. The trailing shield 62 includes a tip 62a facing the tip 60a of the main pole 60 with a write gap WG therebetween, and a joint (back gap part) 50 which is spaced apart from the ABS 43 and connected to the main pole 60. The joint 50 is connected to the top of the main pole 60, i.e., the top of the main pole 60, which is at the back or upward away from the ABS 43 via a non-conductor 52.

The tip 62a of the trailing shield 62 is formed in an elongated rectangular shape. The bottom end surface of the trailing shield 62 is exposed to the ABS 43 of the slider 42. The leading side end surface (main pole side end surface) 62b of the tip 62a extends along the track width direction of the magnetic disk 1 and is inclined toward the trailing side with respect to the ABS 43. The leading side end surface 62b faces the trailing shield side end surface 60c of the main pole 60 at the lower end of the main pole 60 (part of the tip 60a and the squeezed part 60a), approximately parallel to the trailing shield side end surface 60c of the main pole 60 with a write gap WG therebetween.

As in FIG. 7, the magnetic flux control layer 65 has a function of suppressing only the magnetic flux flow from the main pole 60 to the trailing shield 62, i.e., oscillating the spin torque such that the magnetic permeability of the effective write gap WG is negative. In detail, the magnetic flux control layer 65 has a conductive intermediate layer (first non-magnetic conductive layer) 65a, adjustment layer 65b, and conduction cap layer (second non-magnetic conductive layer) 65c having conductivity, and these layers are stacked in order from the first cooling layer 81 side on the main pole 60 to the trailing shield 62 side, in other words, they are stacked in order along the running direction D of the magnetic head. The intermediate layer 65a, adjustment layer 65b, and conduction cap layer 65c each have a film surface which extends parallel to the trailing shield side end surface 60c of the main pole 60, i.e., in the direction intersecting the ABS 43.

The stacking direction of the intermediate layer 65a, adjustment layer 65b, and conduction cap layer 65c is not limited to the above example, but may be stacked in the opposite direction, i.e., from the trailing shield 62 side toward the first cooling layer 81 and the main pole 60 side.

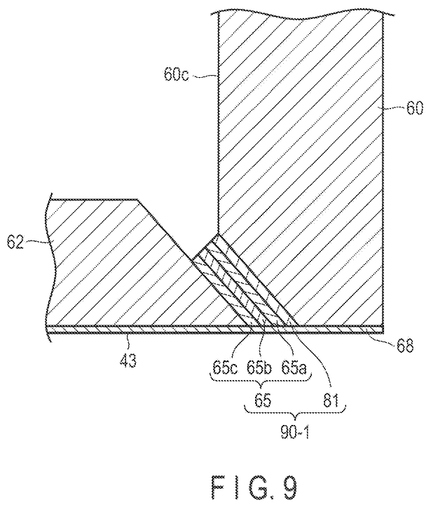

As in FIG. 9, a protective layer 68 is provided with the ABS 43 of the recording head 58, including the main pole 60, first cooling layer 81, flux control layer 65, and trailing shield 62.

The intermediate layer 65a may be formed of, for example, a metallic layer such as Cu, Au, Ag, Al, Ir, NiAl alloy, and other materials which do not interfere with spin conduction. The intermediate layer 65a is formed directly on the trailing shield side end surface 60c of the main pole 60. The adjustment layer 65b includes a magnetic material including at least one of iron, cobalt, and nickel. For example, an alloy material in which at least one of Al, Ge, Si, Ga, B, C, Se, Sn, and Ni is added to FeCo, and at least one material selected from the artificial lattice group consisting of Fe/Co, Fe/Ni, and Co/Ni can be used as the adjustment layer. The thickness of the adjustment layer may be, for example, 2 to 20 nm. The conduction cap layer 65c can be a non-magnetic metal and a material which blocks spin conduction. The conduction cap layer 65c can be formed of, for example, at least one selected from Ta, Ru, Pt, W, Mo, and Ir, or an alloy including at least one thereof. The conduction cap layer 65c is formed directly on the leading end surface 62b of the trailing shield 62. The conduction cap layer can be single or multi-layered.

The intermediate layer 65a is formed to be thick enough to transfer spin torque from the main pole 60 while at the same time making the exchange interaction sufficiently weak, e.g., 1 to 5 nm. The conducting cap layer 65c should be thick enough to block spin torque from the trailing shield 62 while at the same time sufficiently weakening the exchange interaction, e.g., 1 nm or thicker.

The saturation magnetic flux density of the adjustment layer 65b should be small because the spin torque from the main pole 60 requires the direction of magnetization to be opposite to the magnetic field. On the other hand, the saturation flux density of the adjustment layer 65b should be large in order to effectively shield the magnetic flux by the adjustment layer 65b. Since the magnetic field between the write gap WG is about 10-15 kOe, it is difficult to increase the improvement effect even if the saturation magnetic flux density of the adjustment layer 65b is about 1.5 T or higher. In consideration of the above, the saturation magnetic flux density of the adjustment layer 65b should be 1.5 T or less, and more specifically, the adjustment layer 65b should be formed such that the product of the thickness of the adjustment layer 65b and the saturation magnetic flux density is 20 nmT or less.

To ensure that the current flows in a concentrated direction perpendicular to the film surfaces of the intermediate layer 65a, the adjustment layer 65b, and the conduction cap layer 65c, the flux control layer 65 is surrounded by an insulating layer, for example, a protective insulating film 76, except where the part contacting the main pole 60 and the trailing shield 62.

The main pole 60 may be formed of a soft magnetic metal alloy with Fe—Co alloy as its main component. The main pole 60 also functions as an electrode for applying an electric current to the intermediate layer 65a. The trailing shield 62 may be formed of a soft magnetic metal alloy with a Fe—Co alloy as its main component. The trailing shield 62 also serves as an electrode for applying current to the conduction cap layer 65c.

The protective layer 68 is provided to protect the ABS and includes one or more materials, in single or multiple layers. The protective layer has a surface layer formed of, for example, diamond-like carbon.

A base layer formed of Si, for example, may further be provided between the ABS 43 of the recording head 58 and the protective layer 68.

A further underlayer may be provided between the first cooling layer 81 and the intermediate layer 65a.

For example, metals such as Ta and Ru can be used as the base layer. The thickness of the base layer may be, for example, 0.5 to 10 nm. Furthermore, it may be about 2 nm.

In addition, an additional cap layer may be provided between the trailing shield 62 and the conduction cap layer 65c.

At least one non-magnetic element selected from the group consisting of Cu, Ru, W, and Ta can be used as the cap layer. The thickness of the cap layer may be, for example, 0.5 to 10 nm. Furthermore, it may be about 2 nm.

Furthermore, CoFe may be used as a spin-polarized layer between the first cooling layer 81 and the intermediate layer 65a.

As in FIG. 5, the main pole 60 and the trailing shield 62 are each connected to the connection terminal 45 via line 66, and are further connected to the head amplifier IC 11 and the HDC 13 of FIG. 1 via a line member (flexure) 35 of FIG. 2. A current circuit is configured to energize the STO drive current (bias voltage) in series from the head amplifier IC through the main pole 60, STO 65, and trailing shield 62.

The recording coil 64 is connected to the connection terminal 45 via line 77 and further to the head amplifier IC 11 via the flexure 35. When writing signals to a magnetic disk 12, a recording current is supplied to the recording coil 64 from the recording current supply circuit, which is not shown in the figure, of the head amplifier IC 11 to excite the main pole 60 and cause magnetic flux to flow to the main pole 60. The recording current supplied to the recording coil 64 is controlled by the HDC 13.

According to the HDD configured as described above, by driving the VCM 4, the actuator 3 is driven to rotate, and the magnetic head 10 is moved and positioned on a desired track of the magnetic disk 1. As in FIG. 4, the magnetic head 10 is levitated by the air flow C generated between the disk surface and ABS 43 by the rotation of the magnetic disk 1. During HDD operation, the ABS 43 of the slider 42 is facing the disk surface maintaining a gap therebetween. In this state, the magnetic disk 1 is used to read recorded information by the reproducing head 54 and write information by the recording head 58.

The head part 44 of the magnetic head can optionally be equipped with a first heater 76a and a second heater 76b. The first heater 76a is provided in the proximity of the recording head 58, e.g., near the recording coil 64 and the main pole 60. The second heater 76b is provided in the proximity of the read head 54. The first heater 76a and the second heater 76b are each connected to the connection terminal 45 via line and are further connected to the head amplifier IC 11 via the flexure 35.

The first and second heaters 76a and 76b are coiled, for example, and generate heat when energized, causing thermal expansion of the surrounding area. This causes the ABS 43 near the recording head 58 and reproducing head 54 to protrude, bringing them closer to the magnetic disk 1 and lowering the levitation height of the magnetic head. Thus, the levitation height of the magnetic head can be controlled by adjusting the drive voltages supplied to the first and second heaters 76a and 76b, respectively, to control the amount of heat generated.

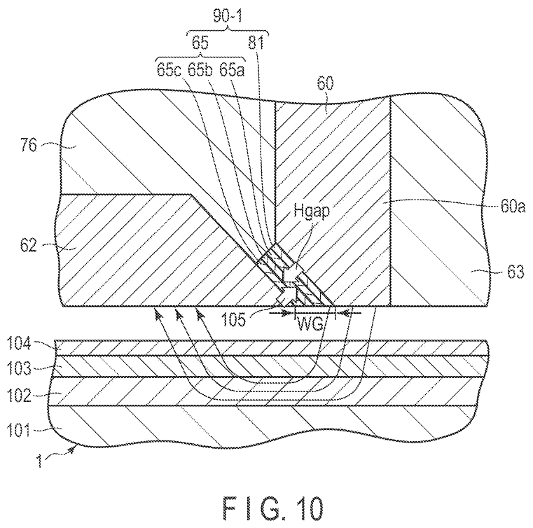

FIG. 10 is a schematic view illustrating the magnetization state in the write gap WG with the flux control layer 65 functioning.

In the above writing of information, as in FIGS. 5 and 10, an alternating current is passed from the power supply 80 to the recording coil 64 to excite the main pole 60 by the recording coil 64 and apply a perpendicular recording magnetic field from the main pole 60 to the recording layer 103 of the magnetic disk 1 directly below. As a result, information is recorded in the magnetic recording layer 103 with a desired track width.

When a recording magnetic field is applied to the magnetic disk 1, an electric current is applied from the power source 74 through line 66, main pole 60, flux control layer 65, and trailing shield 62. This current application causes spin torque from the main pole 60 to act on the adjustment layer 65b of the magnetic flux control layer 65, and the direction of magnetization of the adjustment layer 65b is directed in the opposite direction of the magnetic field (gap magnetic field) Hgap generated between the main pole 60 and the trailing shield 62, as shown by arrow 105. This magnetization reversal causes the adjustment layer 65b to have the effect of shielding the magnetic flux (gap magnetic field Hgap) which flows directly from the main pole 60 to the trailing shield 62. As a result, the magnetic field leaking from the main pole 60 to the write gap WG is reduced, and the degree of convergence of the magnetic flux from the tip 60a of the main pole 60 to the magnetic recording layer 103 of the magnetic disk 1 is improved. This improves the resolution of the recording magnetic field and increases the recording line density. The above is a mode in which the magnetization of the magnetic flux control layer reverses due to the effect of spin torque, but it also includes a mode in which the magnetization of the magnetic flux control layer rotates simultaneously. By applying the high-frequency magnetic field generated by the simultaneous rotation to the magnetic recording layer 103, the recording line density can be increased.

In the magnetic head 10, a single-layer first cooling layer 81 is provided between the magnetic flux control layer 65 and the main pole 60, and the first cooling layer 81 removes heat from the main pole 60 by the Peltier effect when energized to lower the temperature, thereby suppressing heat-induced oxidation of the main pole 60, suppressing degradation of the recording/reproducing elements, and improving the life of the recording/reproducing elements. The first cooling layer 81 has a length W_{CL} in the track width direction TW that is longer than the length W_{MP} in the track width direction TW of the main pole 60 to efficiently cool the main pole 60.

If the length W_{CL} in the track width direction TW is equal to the length W_{SS} in the track width direction TW of the side shield 63, the main pole 60 can be sufficiently cooled, and since the lengths of the side shield 63 and the first cooling layer 81 in the track width direction are processed to match during the manufacturing of the magnetic head, individual patterning is not necessary, and the cost can be lowered.

Here, in the multi-layer 90-1 of the magnetic head 10, a magnetic flux control layer 65 was used as the first conductive layer and a single cooling layer was applied as the first cooling layer 81, but the structure of the first conductive layer 91 (65) and the first cooling layer 81 of the multi-layer 90-1 may be changed in various ways. A second cooling layer 83 may be further provided around the main pole 60 to cool the main pole 60 by the Peltier effect when energized.

Various variations of the magnetic head of the embodiment will be described below.

### Magnetic Head 10-2

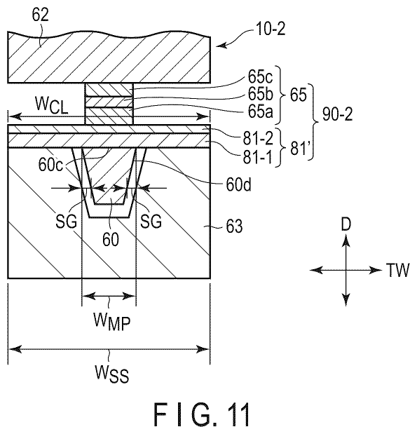

FIG. 11 shows another example of the magnetic head of the embodiment, viewed from the ABS side.

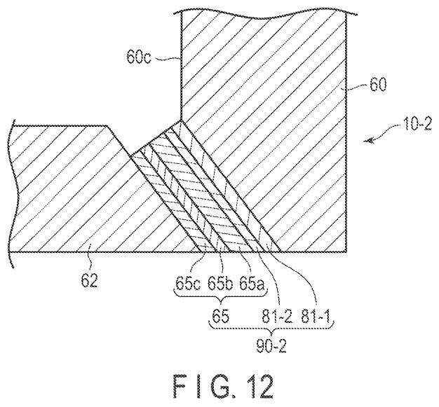

Furthermore, FIG. 12 is a cross-sectional view of the magnetic head of FIG. 11, taken along the track center thereof.

As shown in the figure, the magnetic head 10-2 has the same structure as the magnetic head 10 of FIG. 8, except that instead of a single-layer cooling layer 81, a double-layered first cooling layer 81′ is utilized.

In detail, the magnetic head 10-2 includes a main pole 60 and a multi-layer 90-2 disposed flush with the ABS 43 between the tip 60a of the main pole 60 in the ABS 43 side and the trailing shield 62. The multi-layer 90-2 includes a first cooling layer 81′ on the main pole 60 and a flux control layer 65 as a write assist element on the first cooling layer 81′. The side shields 63 are arranged opposite each other on both sides of the track width direction TW of the main pole 60, each with a side gap SG.

The first cooling layer 81′ has a double-layer structure having a first layer 81-1 and a second layer 81-2 stacked on the first layer 81-1. The length W_{CL} of the first cooling layer 81′ in the track width direction TW is longer than the length W_{MP} of the main pole 60 in the track width direction. The length W_{CL} of at least one of the first layer 81-1 and the second layer 81-2 of the first cooling layer 81′ in the track width direction TW can be longer than the length W_{MP} of the track width direction TW of the main pole 60. Preferably, the length of the first layer 81-1 in the track width direction TW on the main pole 60 side can be longer than the length W_{MP} of the track width direction TW of the main pole 60. Here, the length W_{CL} of the track width direction TW of the first layer 81-1 and the second layer 81-2 is equal to the length W_{SS} of the track width direction TW of the side shield 63. The cross-sectional area of the first cooling layer 81′ perpendicular to the direction of current flow can be larger than the cross-sectional area perpendicular to the direction of current flow of the main pole 60.

For the first layer 81-1, a material having a Peltier coefficient by which heat absorption occurs at the interface with the main pole 60 during current flow depending on the direction of the current can be used. For the second layer 81-2, a material having a Peltier coefficient by which heat dissipation occurs at the interface with the first layer 81-1 depending on the direction of the electric current can be used.

The magnetic flux control layer 65 includes a conductive intermediate layer (first non-magnetic conductive layer) 65a, adjustment layer 65b, and conduction cap layer (second non-magnetic conductive layer) 65c, which are provided in sequence along the running direction D of the magnetic head on the second layer 81-2. The intermediate layer 65a, adjustment layer 65b, and conduction cap layer 65c each have a film surface which extends parallel to the trailing shield side end surface 60c of the main pole 60, i.e., in the direction intersecting the ABS 43, respectively.

The stacking direction of the intermediate layer 65a, adjustment layer 65b, and conduction cap layer 65c is not limited to the above example, but can be stacked in the opposite direction, i.e., from the trailing shield 62 side toward the first cooling layer 81′ and the main pole 60 side.

According to the magnetic head 10-2, using the first cooling layer 81′ whose length W_{CL} in the track width direction TW is longer than the length W_{MP} in the track width direction of the main pole 60, heat is absorbed at the interface between the layer 81-1 of the first cooling layer 81′ and the main pole 60 and heat is dissipated at the interface between the layer 81-1 and layer 81-2 of the first cooling layer 81′ such that heat absorption and heat dissipation due to the temperature difference between the two interfaces are more effective and the main pole 60 is efficiently cooled.

If the cross-sectional area of the first cooling layer 81′ perpendicular to the direction of current flow is larger than the cross-sectional area of the main pole 60 perpendicular to the direction of current flow, the main pole 60 can be cooled more efficiently.

If the length W_{CL} of the track width direction TW of the first layer 81-1 and the second layer 81-2 is equal to the length W_{SS} of the track width direction TW of the side shield 63, sufficient cooling of the main pole 60 is possible, and when manufacturing the magnetic head, the side shield 63, first layer 81-1, and second layer 81-2 in the track width direction can be machined to match the length of each layer, thus eliminating the need for patterning for each layer and resulting in lower cost.

By suppressing heat generation at the main pole 60, deterioration of the recording/reproducing elements due to oxidation of magnetic elements, such as iron, can be suppressed, thereby improving the life of the recording/reproducing elements.

### Magnetic Head 10-3

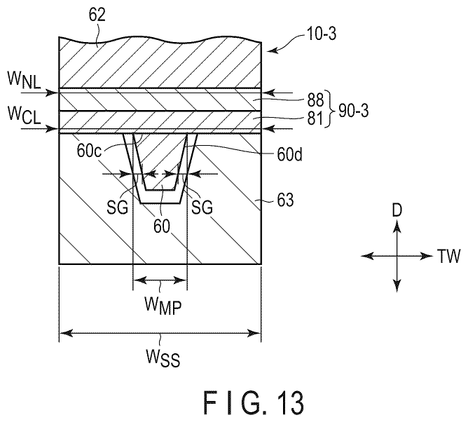

FIG. 13 shows another example of the magnetic head of the embodiment, viewed from the ABS side.

Furthermore, FIG. 14 is a cross-sectional view of the magnetic head of FIG. 13, taken along the track center thereof.

As shown in the figure, a magnetic head 10-3 has the same structure as the magnetic head 10 of FIG. 8, except that as the first conductive layer, a non-magnetic conductive layer 88 used for energy-assisted recording is utilized instead of the flux control layer 65 used for microwave-assisted magnetic recording of FIG. 8.

In detail, the magnetic head 10-3 includes a main pole 60 and a multi-layer 90-3 disposed flush with the ABS 43 between the tip 60a of the main pole 60 in the ABS 43 side and the trailing shield 62. The multi-layer 90-3 includes a single-layered first cooling layer 81 on the main pole 60 and a non-magnetic conductive layer 88 on the first cooling layer 81. The side shields 63 are arranged opposite each other on both sides of the track width direction TW of the main pole 60, each with a side gap SG.

The first cooling layer 81 has a length W_{CL} in the track width direction TW longer than the length W_{MP} in the track width direction TW of the main pole 60. The length W_{CL} of the first cooling layer 81 in the track width direction TW, or the length W_{NL} of the non-magnetic conductive layer 88 in the track width direction TW can be equivalent to the length W_{SS} of the side shield 63 in the track width direction TW, for example. Furthermore, the cross-sectional area of the first cooling layer 81 perpendicular to the direction of current flow can be larger than the cross-sectional area perpendicular to the direction of current flow of the main pole 60. The first cooling layer 81 can be formed of a material having a Peltier coefficient by which heat absorption occurs at the interface with the main pole 60 during current flow depending on the direction of current flow.

The non-magnetic conductive layer 88 generates a magnetic field when current is concentrated when energizing the main pole 60, assisting magnetization reversal and allowing perpendicular magnetic recording.

According to the magnetic head 10-3, the first cooling layer 81 whose length W_{CL} in the track width direction TW is longer than the length W_{MP} in the track width direction TW of the main pole 60, is used to efficiently cool the main pole 60 by causing heat absorption at the interface between the main pole 60 and the first cooling layer 81 when energized.

Furthermore, if the cross-sectional area of the first cooling layer 81 perpendicular to the direction of current flow is larger than the cross-sectional area of the main pole 60 perpendicular to the direction of current flow, the main pole 60 can be cooled more efficiently.

Furthermore, if the length W_{CL} of the track width direction TW of the first cooling layer 81 or the length W_{NL} of the track width direction TW of the non-magnetic conductive layer 88 is equal to the length W_{SS} of the track width direction TW of the side shield 63, sufficient cooling of the main pole 60 is possible, and when manufacturing the magnetic head, the need for patterning for each layer is eliminated, resulting in lower cost.

By suppressing heat generation at the main pole 60, deterioration of the recording/reproducing elements due to oxidation of magnetic elements, such as iron, can be suppressed, thereby improving the life of the recording/reproducing elements.

### Magnetic Head 10-4

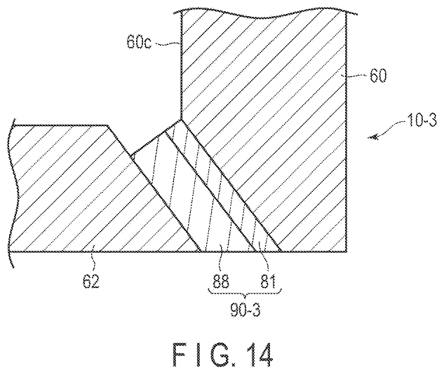

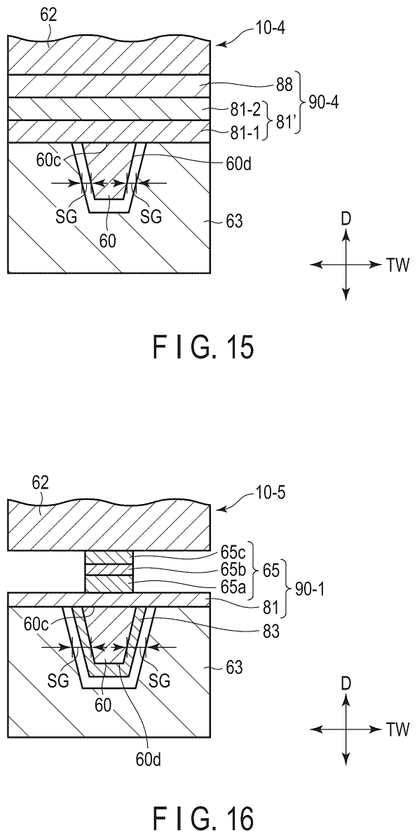

FIG. 15 illustrates another example of the magnetic head of the embodiment, viewed from the ABS side.

As shown in the figure, a magnetic head 10-4 has the same structure as the magnetic head 10-3 of FIGS. 13 and 14, except that instead of a single-layered cooling layer 81, a double-layered first cooling layer 81′ is utilized.

In detail, the magnetic head 10-4 includes a main pole 60 and a multi-layer 90-4 disposed flush with the ABS 43 between the tip 60a of the main pole 60 in the ABS 43 side and the trailing shield 62. The multi-layer 90-4 includes a first cooling layer 81′ on the main pole 60 and a non-magnetic conductive layer 88 on the first cooling layer 81′.

The first cooling layer 81′ has a double-layer structure having a first layer 81-1 and a second layer 81-2 stacked on the first layer 81-1. The side shields 63 are arranged opposite each other on both sides of the track width direction TW of the main pole 60, each with a side gap SG.

The length W_{CL} of the first cooling layer 81′ in the track width direction TW is longer than the length W_{MP} of the main pole 60 in the track width direction. The length W_{CL} of at least one of the first layer 81-1 and the second layer 81-2 of the first cooling layer 81′ in the track width direction TW can be longer than the length W_{MP} of the track width direction TW of the main pole 60. For example, the length of the first layer 81-1 in the track width direction TW on the main pole 60 side can be longer than the length W_{MP} of the track width direction TW of the main pole 60. Furthermore, the length W_{CL} of the track width direction TW of the first layer 81-1 and the second layer 81-2 can be equal to the length W_{SS} of the track width direction TW of the side shield 63. Furthermore, the cross-sectional area of the first cooling layer 81′ perpendicular to the direction of current flow can be larger than the cross-sectional area perpendicular to the direction of current flow of the main pole 60.

For the first layer 81-1 of the first cooling layer 81′, a material having a Peltier coefficient by which heat absorption occurs at the interface with the main pole 60 during current flow depending on the direction of the current can be used. For the second layer 81-2, a material having a Peltier coefficient by which heat dissipation occurs at the interface with the first layer 81-1 depending on the direction of the electric current can be used.

The non-magnetic conductive layer 88 generates a magnetic field when current is concentrated when energizing the main pole 60, assisting magnetization reversal and allowing perpendicular magnetic recording.

According to the magnetic head 10-4, using the first cooling layer 81′ whose length W_{CL} in the track width direction TW is longer than the length W_{MP} in the track width direction of the main pole 60, heat is absorbed at the interface between the first layer 81-1 of the first cooling layer 81′ and the main pole 60 and heat is dissipated at the interface between the first layer 81-1 and second layer 81-2 of the first cooling layer 81′ such that heat absorption and heat dissipation due to the temperature difference between the two interfaces are more effective, and the main pole 60 is efficiently cooled.

If the cross-sectional area of the first cooling layer 81′ perpendicular to the direction of current flow is larger than the cross-sectional area of the main pole 60 perpendicular to the direction of current flow, the main pole 60 can be cooled more efficiently.

If the length W_{CL} of the track width direction TW of the first layer 81-1 and the second layer 81-2 is equal to the length W_{SS} of the track width direction TW of the side shield 63, sufficient cooling of the main pole 60 is possible, and when manufacturing the magnetic head, the side shield 63, first layer 81-1, or second layer 81-2 in the track width direction can be machined to match the length of each layer, thus eliminating the need for patterning for each layer and resulting in lower cost.

By suppressing heat generation at the main pole 60, deterioration of the recording/reproducing elements due to oxidation of magnetic elements, such as iron, can be suppressed, thereby improving the life of the recording/reproducing elements.

Next, a magnetic head using the second cooling layer will be described.

The second cooling layer can be further provided with at least some sides of the tip of the main pole 60 other than side 60c, for example, in the track width direction. The second cooling layer may be multilayered with one or two or more layers stacked on top of each other. The second cooling layer may also be two or more separate layers. The second cooling layer can be provided to surround the main pole together with the first cooling layer as viewed from the ABS. For example, by providing the first cooling layer on the side surface 60c of the auxiliary pole 62 side (trailing shield side end surface) of the tip of the main pole 60, and the second cooling layer on a side surface of the tip of the main pole 60 other than side surface 60c, the first and second cooling layers can be formed to surround the main pole.

A material of the second cooling layer can be selected, for example, from the conductive material used for the first cooling layer. The material of the same composition as the first cooling layer can be used as the material for the second cooling layer. If the material of the same composition as the first cooling layer is used, heat transfer between the cooling layers does not occur and a uniform cooling effect tends to be obtained. A material of a different composition from the first cooling layer may be used as the material for the second cooling layer. When a material with a composition different from that of the first cooling layer is used, heat transfer occurs between the cooling layers, and depending on the choice of material, there tends to be a difference in the cooling effect on the main poles.

### Magnetic Head 10-5

FIG. 16 shows another example of the magnetic head of the embodiment, viewed from the ABS side.

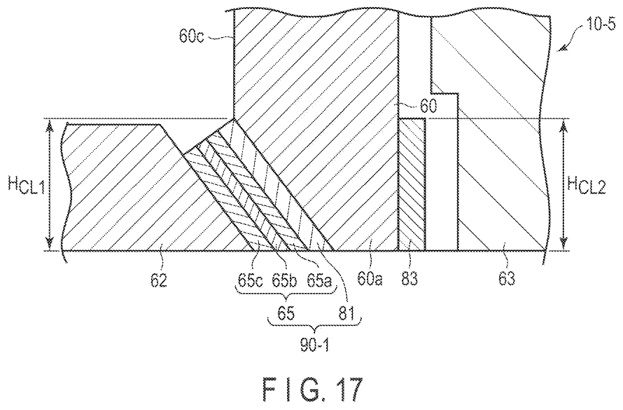

FIG. 17 is a cross-sectional view of the magnetic head of FIG. 16, taken along the track center thereof.

As shown in the figure, the magnetic head 10-5 has the same structure as the magnetic head 10 of FIG. 8, except that a second cooling layer 83 which cools the main pole 60 by the Peltier effect when energized is further provided on the side 60d of the tip 60a of the main pole 60 in the ABS 43 side, except for the trailing shield side end surface 60c.

In detail, the magnetic head 10-5 includes a main pole 60, multi-layer 90-1 disposed flush with the ABS 43 between the tip 60a of the main pole 60 in the ABS 43 side and the trailing shield 62, and second cooling layer 83 on the side 60d of the tip 60a other than the trailing side end surface 60c. The multi-layer 90-1 includes a first cooling layer 81 provided with the main pole 60 and a flux control layer 65 as a write assist element provided with the first cooling layer 81. The side shields 63 are arranged opposite each other on both sides of the track width direction TW of the main pole 60, each with a side gap SG.

The second cooling layer 83 is located between the tip 60a of the main pole 60 in the ABS 43 side and the side shield 63. The second cooling layer 83, together with the first cooling layer 81 on the trailing shield side end surface 60c, can be provided to surround the sides of the tip 60a of the main pole 60. As in FIG. 17, the height H_{CL2} of the second cooling layer 83 in the head levitation direction can be equal to the height H_{CL1} of the first cooling layer 81 in the head levitation direction. The height H_{CL2} of the second cooling layer 83 in the head levitation direction can be higher than the height H_{CL1} in the head levitation direction.

The first cooling layer 81 has a length W_{CL} in the track width direction TW longer than the length W_{MP} in the track width direction of the main pole 60. The length W_{CL} of the first cooling layer 81 in the track width direction TW can be equal to the length W_{SS} of the side shield 63 in the track width direction TW. The cross-sectional area of the first cooling layer 81 perpendicular to the direction of current flow can be larger than the cross-sectional area of the main pole 60 perpendicular to the direction of current flow.

The first and second cooling layers 81 and 83 can be formed of materials having Peltier coefficients by which heat absorption occurs at the interface with the main pole 60 during current flow, depending on the direction of the current.

The magnetic flux control layer 65 includes a conductive intermediate layer (first non-magnetic conductive layer) 65a, adjustment layer 65b, and conduction cap layer (second non-magnetic conductive layer) 65c, which are provided in sequence along the running direction D of the magnetic head on the first cooling layer 81. The intermediate layer 65a, adjustment layer 65b, and conduction cap layer 65c each have a film surface which extends parallel to the trailing shield side end surface 60c of the main pole 60, i.e., in the direction intersecting the ABS 43.

The stacking direction of the intermediate layer 65a, adjustment layer 65b, and conduction cap layer 65c is not limited to the above example, but may be stacked in the opposite direction, i.e., from the trailing shield 62 side toward the first cooling layer 81 and the main pole 60 side.

According to the magnetic head 10-5, by using the first cooling layer 81 whose length W_{CL} in the track width direction TW is longer than the length W_{MP} in the track width direction of the main pole 60, and by causing heat absorption at the interface between the main pole 60 and the first cooling layer 81 and at the interface between the main pole 60 and the second cooling layer 83 during current flow, allowing the main pole 60 to be cooled more efficiently than if heat is absorbed only at the interface between the main pole 60 and the first cooling layer 81 when energizing. Furthermore, by providing the second cooling layer 83 together with the first cooling layer 81 so as to surround the sides of the tip 60a of the main pole 60, the main pole 60 can be cooled even more efficiently. Furthermore, if the height H_{CL2} of the second cooling layer 83 in the head levitation direction is equal to or greater than the height H_{CL1} of the first cooling layer 81 in the head floating direction, the area to be heated can be cooled over a wider area.

If the cross-sectional area of the first cooling layer 81 perpendicular to the direction of current flow is larger than the cross-sectional area of the main pole 60 perpendicular to the direction of current flow, the main pole 60 can be cooled more efficiently.

Furthermore, if the length W_{CL} of the track width direction TW of the first cooling layer 81 is equal to the length W_{SS} of the track width direction TW of the side shield 63, sufficient cooling of the main pole 60 is possible, and when manufacturing the magnetic head, the side shield 63 and the first cooling layer 81 in the track width direction can be machined to match the length of each layer, thus eliminating the need for patterning for each layer and resulting in lower cost.

As above, by suppressing heat generation at the main pole 60, the deterioration of the recording/reproducing elements due to oxidation of magnetic elements, such as iron, can be suppressed and the life of the recording/reproducing elements can be improved.

### Magnetic Head 10-6

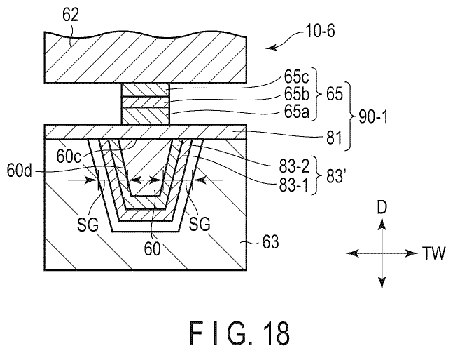

FIG. 18 illustrates another example of the magnetic head of the embodiment, viewed from the ABS side.

As shown in the figure, the magnetic head 10-6 has the same structure as the magnetic head 10-5 of FIGS. 16 and 17, except that instead of a second cooling layer 83 on the side 60d of the main pole 60 other than the trailing shield side end surface 60c, a double-layered second cooling layer 83′ to cool the main pole 60 by Peltier effect when energized is utilized.

In detail, the magnetic head 10-6 includes a main pole 60, multi-layer 90-1 disposed flush with the ABS 43 between the tip 60a of the main pole 60 in the ABS 43 side and the trailing shield 62, and second cooling layer 83′ on the side 60d of the tip 60a other than the trailing side end surface 60c. The multi-layer 90-1 includes a first cooling layer 81 provided with the main pole 60 and a flux control layer 65 as a write assist element provided with the first cooling layer 81. The side shields 63 are arranged opposite each other on both sides of the track width direction TW of the main pole 60, each with a side gap SG.

The second cooling layer 83′ has a double-layer structure having a second layer 83-2 stacked on the side 60d of the tip 60a of the main pole 60 in the ABS 43 side other than the trailing shield side end surface 60c, and a first layer 83-1. The double-layered second cooling layer 83′ is located between the tip 60a of the main pole 60 in the ABS 43 side and the side shield 63. The second cooling layer 83′ can be provided together with the first cooling layer 81 on the trailing shield side end surface 60c to surround the sides of the tip 60a of the main pole 60.

The first cooling layer 81 has a length W_{CL} in the track width direction TW longer than the length W_{MP} in the track width direction of the main pole 60. The length W_{CL} of the first cooling layer 81 in the track width direction TW can be equal to the length W_{SS} of the side shield 63 in the track width direction TW. The cross-sectional area of the first cooling layer 81 perpendicular to the direction of current flow can be larger than the cross-sectional area of the main pole 60 perpendicular to the direction of current flow.

The first cooling layer 81 and the second layer 83-2 of the second cooling layer 83′ can be formed of materials having Peltier coefficients by which heat absorption occurs at the interface with the main pole 60 during current flow, depending on the direction of the current. The first layer 83-1 can be formed of a material having a Peltier coefficient such that heat dissipation occurs at the interface with the second layer 83-2 during current flow.

The magnetic flux control layer 65 includes a conductive intermediate layer (first non-magnetic conductive layer) 65a, adjustment layer 65b, and conduction cap layer (second non-magnetic conductive layer) 65c, which are provided in sequence along the running direction D of the magnetic head on the first cooling layer 81. The intermediate layer 65a, adjustment layer 65b, and conduction cap layer 65c each have a film surface which extends parallel to the trailing shield side end surface 60c of the main pole 60, i.e., in the direction intersecting the ABS 43.

The stacking direction of the intermediate layer 65a, adjustment layer 65b, and conduction cap layer 65c is not limited to the above example, but may be stacked in the opposite direction, i.e., from the trailing shield 62 side toward the first cooling layer 81 and the main pole 60 side.

According to the magnetic head 10-6, by using the first cooling layer 81 whose length W_{CL} in the track width direction TW is longer than the length W_{MP} in the track width direction of the main pole 60, and by causing heat absorption at the interface between the main pole 60 and the first cooling layer 81 and at the interface between the main pole 60 and the second layer 83-2 of the second cooling layer 83′ during current flow, and by causing heat dissipation at the interface between the second layer 83-2 and the first layer 83-1, the heat absorption and the heat dissipation are performed more effectively, allowing the main pole 60 to be cooled more efficiently. Furthermore, by providing the second cooling layer 83′ together with the first cooling layer 81 so as to surround the sides of the tip 60a of the main pole 60, the main pole 60 can be cooled even more efficiently.

If the cross-sectional area of the first cooling layer 81 perpendicular to the direction of current flow is larger than the cross-sectional area of the main pole 60 perpendicular to the direction of current flow, the main pole 60 can be cooled more efficiently.

Furthermore, if the length W_{CL} of the track width direction TW of the first cooling layer 81 is larger than the length W_{MP} of the track width direction TW of the main pole 60, that is, for example, is equal to the length W_{SS} of the track width direction TW of the side shield 63, sufficient cooling of the main pole 60 is possible, and when manufacturing the magnetic head, the side shield 63 and the first cooling layer 81 in the track width direction can be machined to match the length of each layer, thus eliminating the need for patterning for each layer and resulting in lower cost.

As above, by suppressing heat generation at the main pole 60, the deterioration of the recording/reproducing elements due to oxidation of magnetic elements, such as iron, can be suppressed and the life of the recording/reproducing elements can be improved.

### Magnetic Head 10-7

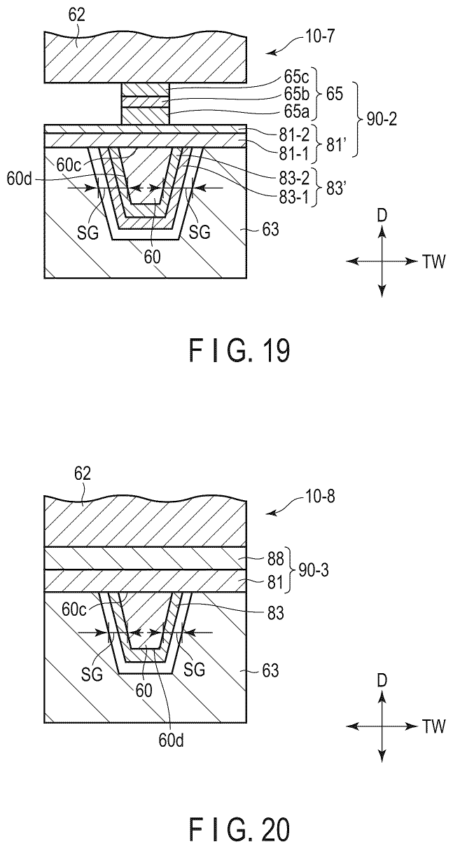

FIG. 19 illustrates another example of the magnetic head of the embodiment, viewed from the ABS side.

As shown in the figure, a magnetic head 10-7 has the same structure as the magnetic head 10-5 of FIGS. 16 and 17, except that instead of a single-layered first cooling layer 81, a double-layered first cooling layer 81′ is utilized, and instead of a second cooling layer 83, a double-layered second cooling layer 83′ is utilized.

In detail, the magnetic head 10-7 includes a main pole 60, multi-layer 90-2 disposed flush with the ABS 43 between the tip 60a of the main pole 60 in the ABS 43 side and the trailing shield 62, and second cooling layer 83′ on the side 60d of the tip 60a other than the trailing side end surface 60c. The multi-layer 90-2 includes a first cooling layer 81′ provided with the main pole 60 and a flux control layer 65 as a write assist element provided with the first cooling layer 81′. The side shields 63 are arranged opposite each other on both sides of the track width direction TW of the main pole 60, each with a side gap SG.

The first cooling layer 81′ has a double-layered structure having a first layer 81-1 and a second layer 81-2 stacked on the first layer 81-1. The length W_{CL} of the first cooling layer 81′ in the track width direction TW is longer than the length W_{MP} of the main pole 60 in the track width direction. The length W_{CL} of at least one of the first layer 81-1 and the second layer 81-2 of the first cooling layer 81′ in the track width direction TW can be longer than the length W_{MP} of the track width direction TW of the main pole 60. For example, the length of the first layer 81-1 in the track width direction TW on the main pole 60 side can be longer than the length W_{MP} of the track width direction TW of the main pole 60. Furthermore, as in the figure, the length W_{CL} of the track width direction TW of the first layer 81-1 and the second layer 81-2 can be equal to the length W_{SS} of the track width direction TW of the side shield 63. Furthermore, the cross-sectional area of the first cooling layer 81′ perpendicular to the direction of current flow can be larger than the cross-sectional area perpendicular to the direction of current flow of the main pole 60.

The second cooling layer 83′ is a double-layer structure with a second layer 83-2 on the side 60d of the tip 60a of the main pole 60 in the ABS 43 side, other than the trailing shield side end surface 60c, and a first layer 83-1 on the second layer 83-2. The second cooling layer 83′ is located between the tip 60a of the main pole 60 in the ABS 43 side and the side shield 63. The second cooling layer 83′ can be provided together with the first cooling layer 81 on the trailing shield side end surface 60c to surround the side of the tip 60a of the main pole 60.

For the first layer 81-1 of the first cooling layer 81′ and the second layer 83-2 of the second cooling layer 83′, a material having a Peltier coefficient by which heat absorption occurs at the interface with the main pole 60 during current flow depending on the direction of the current can be used. For the second layer 81-2 of the first cooling layer 81′, a material having a Peltier coefficient by which heat dissipation occurs at the interface with the first layer 81-1 can be used, and for the first layer 83-1 of the second cooling layer 83′, a material having a Peltier coefficient by which heat dissipation occurs at the interface with the first layer 83-2 can be used.

The magnetic flux control layer 65 includes a conductive intermediate layer (first non-magnetic conductive layer) 65a, adjustment layer 65b, and conduction cap layer (second non-magnetic conductive layer) 65c, which are provided in sequence along the running direction D of the magnetic head on the first cooling layer 81. The intermediate layer 65a, adjustment layer 65b, and conduction cap layer 65c each have a film surface which extends parallel to the trailing shield side end surface 60c of the main pole 60, i.e., in the direction intersecting the ABS 43.

The stacking direction of the intermediate layer 65a, adjustment layer 65b, and conduction cap layer 65c is not limited to the above example, but may be stacked in the opposite direction, i.e., from the trailing shield 62 side toward the first cooling layer 81 and the main pole 60 side.

According to the magnetic head 10-7, by using the first cooling layer 81′ whose length W_{CL} in the track width direction TW is longer than the length W_{MP} in the track width direction of the main pole 60, and by causing heat absorption at the interface between the main pole 60 and the first layer 81-1 of the first cooling layer 81 and at the interface between the main pole 60 and the second layer 83-2 of the second cooling layer 83′ during current flow, and by causing heat dissipation at the interface between the first layer 81-1 and the second layer 81-2 of the first cooling layer 81′ and between the second layer 83-2 and the first layer 83-1 of the second cooling layer 83′, the heat absorption and the heat dissipation are performed more effectively, allowing the main pole 60 to be cooled more efficiently. Furthermore, by providing the second cooling layer 83′ together with the first cooling layer 81 so as to surround the sides of the tip 60a of the main pole 60, the main pole 60 can be cooled even more efficiently.

Furthermore, if the cross-sectional area of the first cooling layer 81′ perpendicular to the direction of current flow is larger than the cross-sectional area of the main pole 60 perpendicular to the direction of current flow, the main pole 60 can be cooled more efficiently.

If the length W_{CL} of the track width direction TW of the first layer 81 and the second layer 81-2 is equal to the length W_{SS} of the track width direction TW of the side shield 63, sufficient cooling of the main pole 60 is possible, and when manufacturing the magnetic head, the side shield 63, the first layer 81-1, and the second layer 81-2 in the track width direction can be machined to match the length of each layer, thus eliminating the need for patterning for each layer and resulting in lower cost.

### Magnetic Head 10-8

FIG. 20 shows another example of the magnetic head of the embodiment, viewed from the ABS side.

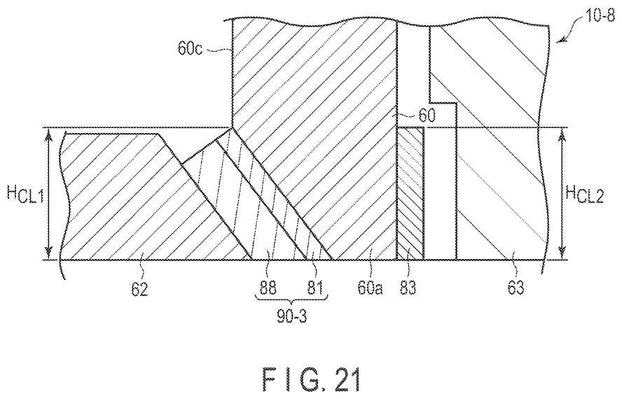

FIG. 21 is a cross-sectional view of the magnetic head of FIG. 20, taken along the track center thereof.

As shown in the figure, the magnetic head 10-8 has the same structure as the magnetic head 10-3 of FIG. 13, except that a second cooling layer 83 which cools the main pole 60 by the Peltier effect when energized is further provided on the side 60d of the tip 60a of the main pole 60 in the ABS 43 side, except for the trailing shield side end surface 60c.

In detail, the magnetic head 10-8 includes a main pole 60, multi-layer 90-3 disposed flush with the ABS 43 between the tip 60a of the main pole 60 in the ABS 43 side and the trailing shield 62, and second cooling layer 83 on the side 60d of the tip 60a other than the trailing side end surface 60c. The multi-layer 90-3 includes a single-layer first cooling layer 81 provided with the main pole 60 and a non-magnetic conductive layer 88 provided on the first cooling layer 81. The non-magnetic conductive layer 88 generates a magnetic field when current is concentrated when energizing the main pole 60, assisting magnetization reversal and allowing perpendicular magnetic recording. The side shields 63 are arranged opposite each other on both sides of the track width direction TW of the main pole 60, each with a side gap SG.

The first cooling layer 81 has a length W_{CL} in the track width direction TW longer than the length W_{MP} in the track width direction of the main pole 60. For example, the length W_{CL} of the first cooling layer 81 in the track width direction TW can be equal to the length W_{SS} of the side shield 63 in the track width direction TW. Furthermore, the cross-sectional area of the first cooling layer 81′ perpendicular to the direction of current flow can be larger than the cross-sectional area of the main pole 60 perpendicular to the direction of current flow.

The second cooling layer 83 can be provided with the side 60d of the tip 60a of the main pole 60 in the ABS 43 side other than the trailing shield side end surface 60c, and provided between the tip 60a of the main pole 60 in the ABS 43 side and the side shield 63. The second cooling layer 83 together with the first cooling layer 81 provided with the trailing shield side end surface 60c can be provided to surround the side surface of the tip 60a of the main pole 60.

The first cooling layer 81 and the second cooling layer 83 can be formed of materials having Peltier coefficients by which heat absorption occurs at the interface with the main pole 60 during current flow, depending on the direction of the current.

According to the magnetic head 10-8, by causing heat absorption at the interface between the main pole 60 and the first cooling layer 81 and at the interface between the main pole 60 and the second cooling layer 83 during current flow, allowing the main pole 60 to be cooled more efficiently. Furthermore, by providing the second cooling layer 83 together with the first cooling layer 81 so as to surround the sides of the tip 60a of the main pole 60, the main pole 60 can be cooled even more efficiently.

Furthermore, if the cross-sectional area of the first cooling layer 81 perpendicular to the direction of current flow is larger than the cross-sectional area of the main pole 60 perpendicular to the direction of current flow, the main pole 60 can be cooled more efficiently.

If the length W_{CL} of the track width direction TW of the first cooling layer 81 larger than the length W_{MP} of the main pole 60 in the track width direction TW, that is, is equal to the length W_{SS} of the track width direction TW of the side shield 63, sufficient cooling of the main pole 60 is possible, and when manufacturing the magnetic head, the side shield 63 and the first cooling layer 81 in the track width direction can be machined to match the length of each layer, thus eliminating the need for patterning for each layer and resulting in lower cost.

### Magnetic Head 10-9

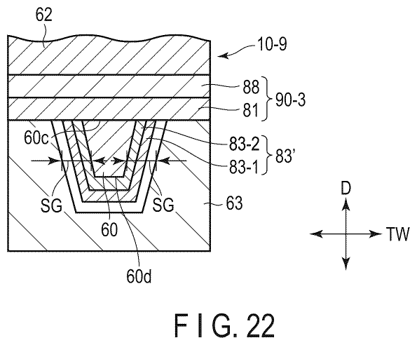

FIG. 22 illustrates another example of the magnetic head of the embodiment, viewed from the ABS side.

As shown in the figure, the magnetic head 10-9 has the same structure as the magnetic head 10-8 of FIGS. 20 and 21, except that instead of a second cooling layer 83, a double-layered second cooling layer 83′ to cool the main pole 60 by Peltier effect when energized is utilized.

In detail, the magnetic head 10-9 includes a main pole 60, multi-layer 90-3 disposed flush with the ABS 43 between the tip 60a of the main pole 60 in the ABS 43 side and the trailing shield 62, and second cooling layer 83′ on the side 60d of the tip 60a other than the trailing side end surface 60c. The multi-layer 90-3 includes a single-layer first cooling layer 81 provided with the main pole 60 and a non-magnetic conductive layer 88 provided on the first cooling layer 81. The non-magnetic conductive layer 88 generates a magnetic field when current is concentrated when energizing the main pole 60, assisting magnetization reversal and allowing perpendicular magnetic recording. The side shields 63 are arranged opposite each other on both sides of the track width direction TW of the main pole 60, each with a side gap SG.

The first cooling layer 81 has a length W_{CL} in the track width direction TW longer than the length W_{MP} in the track width direction of the main pole 60. For example, the length W_{CL} of the first cooling layer 81 in the track width direction TW can be equal to the length W_{SS} of the side shield 63 in the track width direction TW. Furthermore, the cross-sectional area of the first cooling layer 81′ perpendicular to the direction of current flow can be larger than the cross-sectional area of the main pole 60 perpendicular to the direction of current flow.

The second cooling layer 83′ is a double-layer structure with a second layer 83-2 on the side 60d of the tip 60a of the main pole 60 in the ABS 43 side, other than the trailing shield side end surface 60c, and a first layer 83-1 on the second layer 83-2. The second cooling layer 83′ is located between the tip 60a of the main pole 60 in the ABS 43 side and the side shield 63. The second cooling layer 83′ can be provided together with the first cooling layer 81 on the trailing shield side end surface 60c to surround the side of the tip 60a of the main pole 60.

For the first cooling layer 81 and the second layer 83-2 of the second cooling layer 83′, a material having a Peltier coefficient by which heat absorption occurs at the interface with the main pole 60 during current flow depending on the direction of the current can be used. For the first layer 81-1 of the first cooling layer 81, a material having a Peltier coefficient by which heat dissipation occurs at the interface with the second layer 81-2 during current flow can be used.

According to the magnetic head 10-9, by using the first cooling layer 81 whose length W_{CL} in the track width direction TW is longer than the length W_{MP} in the track width direction of the main pole 60, and by causing heat absorption at the interface between the main pole 60 and the first cooling layer 81 and at the interface between the main pole 60 and the second layer 83-2 of the second cooling layer 83′ during current flow, and by causing heat dissipation at the interface between the second layer 83-2 and the first layer 83-1, the heat absorption and the heat dissipation are performed effectively by a temperature difference between the interface between the main pole 60 and the second layer 83-2 of the second cooling layer 83′ and the interface between the second layer 83-2 and the first layer 83-1, allowing the main pole 60 to be cooled more efficiently than the magnetic head 10-8. Furthermore, by providing the second cooling layer 83′ together with the first cooling layer 81 so as to surround the sides of the tip 60a of the main pole 60, the main pole 60 can be cooled even more efficiently.

Furthermore, if the cross-sectional area of the first cooling layer 81 perpendicular to the direction of current flow is larger than the cross-sectional area of the main pole 60 perpendicular to the direction of current flow, the main pole 60 can be cooled more efficiently.

If the length W_{CL} of the track width direction TW of the first cooling layer 81 larger than the length W_{MP} of the main pole 60 in the track width direction TW, that is, is equal to the length W_{SS} of the track width direction TW of the side shield 63, sufficient cooling of the main pole 60 is possible, and when manufacturing the magnetic head, the side shield 63 and the first cooling layer 81 in the track width direction can be machined to match the length of each layer, thus eliminating the need for patterning for each layer and resulting in lower cost.

### Magnetic Head 10-10

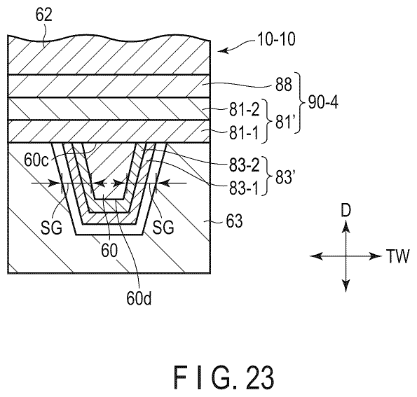

FIG. 23 illustrates another example of the magnetic head of the embodiment, viewed from the ABS side.

As shown in the figure, a magnetic head 10-10 has the same structure as the magnetic head 10-3 of FIGS. 20 and 21, except that instead of a first cooling layer 81, a double-layered first cooling layer 81′ is utilized, and instead of a second cooling layer 83, a double-layered second cooling layer 83′ is utilized.

In detail, the magnetic head 10-10 includes a main pole 60, multi-layer 90-4 disposed flush with the ABS 43 between the tip 60a of the main pole 60 in the ABS 43 side and the trailing shield 62, and second cooling layer 83′ on the side 60d of the tip 60a other than the trailing side end surface 60c. The multi-layer 90-4 includes a first cooling layer 81′ provided with the main pole 60 and a non-magnetic conductive layer 88 provided on the first cooling layer 81. The non-magnetic conductive layer 88 generates a magnetic field when current is concentrated when energizing the main pole 60, assisting magnetization reversal and allowing perpendicular magnetic recording. The side shields 63 are arranged opposite each other on both sides of the track width direction TW of the main pole 60, each with a side gap SG.

The first cooling layer 81′ has a double-layered structure having a first layer 81-1 and a second layer 81-2 stacked on the first layer 81-1. The lengths W_{CL} of the first layer 81-1 and the second layer 81-2 in the track width direction TW are longer than the length W_{MP} of the main pole 60 in the track width direction. The length W_{CL} of at least one of the first layer 81-1 and the second layer 81-2 in the track width direction TW can be longer than the length W_{MP} of the track width direction TW of the main pole 60. Preferably, the length of the first layer 81-1 in the track width direction TW on the main pole 60 side can be longer than the length W_{MP} of the track width direction TW of the main pole 60. In this example, the length W_{CL} of the track width direction TW of the first layer 81-1 and the second layer 81-2 is equal to the length W_{SS} of the track width direction TW of the side shield 63, for example. Furthermore, the cross-sectional area of the first cooling layer 81′ perpendicular to the direction of current flow can be larger than the cross-sectional area perpendicular to the direction of current flow of the main pole 60.

The second cooling layer 83′ is a double-layer structure with a second layer 83-2 on the side 60d of the tip 60a of the main pole 60 in the ABS 43 side, other than the trailing shield side end surface 60c, and a first layer 83-1 on the second layer 83-2. The second cooling layer 83′ is located between the tip 60a of the main pole 60 in the ABS 43 side and the side shield 63. The second cooling layer 83′ can be provided together with the first layer 81-1 of the first cooling layer 81 on the trailing shield side end surface 60c to surround the side of the tip 60a of the main pole 60.

For the first layer 81-1 of the first cooling layer 81′ and the second layer 83-2 of the second cooling layer 83′, a material having a Peltier coefficient by which heat absorption occurs at the interface with the main pole 60 during current flow depending on the direction of the current can be used. For the first layer 83-1 of the second cooling layer 83′, a material having a Peltier coefficient by which heat dissipation occurs at the interface with the first layer 81-1 can be used.

According to the magnetic head 10-10, by using the first cooling layer 81′ whose length W_{CL} in the track width direction TW is longer than the length W_{MP} in the track width direction of the main pole 60, and by causing heat absorption at the interface between the main pole 60 and the first layer 81-1 of the first cooling layer 81 and at the interface between the main pole 60 and the second layer 83-2 of the second cooling layer 83′ during current flow, and by causing heat dissipation at the interface between the first layer 81-1 and the second layer 81-2 of the first cooling layer 81′ and between the second layer 83-2 and the first layer 83-1 of the second cooling layer 83′, the heat absorption and the heat dissipation are performed more effectively, allowing the main pole 60 to be cooled more efficiently. Furthermore, by providing the second cooling layer 83′ together with the first cooling layer 81 so as to surround the sides of the tip 60a of the main pole 60, the main pole 60 can be cooled even more efficiently.

Furthermore, if the cross-sectional area of the first cooling layer 81′ perpendicular to the direction of current flow is larger than the cross-sectional area of the main pole 60 perpendicular to the direction of current flow, the main pole 60 can be cooled more efficiently.

If the length W_{CL} of the track width direction TW of the first layer 81 and the second layer 81-2 is equal to the length W_{SS} of the track width direction TW of the side shield 63, sufficient cooling of the main pole 60 is possible, and when manufacturing the magnetic head, the side shield 63, the first layer 81-1, and the second layer 81-2 in the track width direction can be machined to match the length of each layer, thus eliminating the need for patterning for each layer and resulting in lower cost.

Hereinafter, examples will be described to specifically explain the embodiment.

### Example 1

A magnetic head of the embodiment was prepared as follows.

Preparation of Magnetic Disk Devices Using Magnetic Head with Single-Layer First Cooling Layer

First, 3 nm of CuNi alloy was formed as a single-layer first cooling layer on the main pole consisting mainly of FeCo, using DC magnetron sputtering method for layers with the following materials and thicknesses, respectively. Then, 2 nm of Ru as the base layer, 1 nm of Cu (first conductive layer), 10 nm of FeCo (adjustment layer), and 4 nm of Ru (second conductive layer) as the magnetic flux control layer were stacked in sequence. Note that, the same materials as the intermediate layer 65a, adjustment layer 65b, and conduction cap layer 65c as in FIGS. 7 to 9 can be used as the materials for the first conductive layer, adjustment layer, and second conducting layer, for example.

Next, a mask layer was formed to define the size of the magnetic flux control layer in the stripe height direction, and then the magnetic flux control layer was etched by ion beam etching (IBE) until the cooling layer was exposed. The peripheral portions of the magnetic flux control layer ware deposited with SiOx of insulating film, and then the mask layer was removed. In addition, a mask layer to define the size in the track width direction was also applied, etched in the same manner, and the magnetic flux control layer was processed by depositing SiOx of insulating film on the peripheral portions of the element.

Next, NiFe was formed as a trailing shield on the second conductive layer.

Then, a Si underlayer of approximately 1 nm was deposited on the main magnetic pole in the ABS side, first cooling layer, magnetic flux control layer, trailing shield, and insulating film by sputtering, and a protective layer of 1.6 nm thick was formed by depositing diamond-like carbon on the Si underlayer by CVD. This resulted in a magnetic head with a structure similar to that shown in FIG. 8, and with single-layer first cooling layer whose length in the track width direction is longer than the track width length of the main pole.

In the above magnetic head, the Peltier coefficient of the main pole and the first cooling layer is π_{MP}>π₁. Therefore, when a current flows from the trailing shield through the flux control layer in the direction of the main pole, heat absorption occurs at the interface.

Similarly, multiple magnetic heads with single-layer first cooling layer were fabricated and incorporated into a magnetic disk device with 18 magnetic heads and 9 magnetic disks per HDD, for a total of 50 magnetic disk devices.

Preparation of Magnetic Disk Devices Using Magnetic Head with Double-Layered First Cooling Layer

A magnetic disk device with the same structure as that of FIG. 11 was prepared such that, instead of the magnetic head with single-layer first cooling layer, a magnetic head with a double-layered first cooling layer consisting of 2 nm of CuNi alloy in the first layer and 2 nm of Ru in the second layer was utilized. A total of 50 magnetic disk devices were prepared using magnetic heads with a double-layer first cooling layer whose length in the track width direction is longer than the length in the track width direction of the main poles.

In this magnetic head, the Peltier coefficients at the interface between the main pole and the first cooling layer are π_{MP}>π₁ and π₁<π₂. Therefore, when a current flows from the trailing shield through the magnetic flux control layer, to the main pole, heat absorption occurs at the interface between the main pole and the first cooling layer and heat dissipation occurs at the interface between the first and second layers.

### Preparation of Magnetic Disk of Comparative Example 1

Furthermore, a magnetic disk device of comparative example 1 with the same structure as the magnetic disk device with the magnetic head with a single-layer first cooling layer was prepared except that the first cooling layer was not prepared. A total of 50 magnetic disk devices with the above structure were prepared.

As a long-time energization test, the resulting magnetic disk devices were energized for 7,000 hours under an ambient temperature of 65° C. with an applied voltage of 300 mV in the direction of the trailing shield, flux control layer, and main pole.

As a result, there were multiple heads whose bit error rate (BER) had deteriorated at 7,000 hours relative to the BER value (error rate per bit) before the energization test.

The obtained BER values were determined as OK/NG with a cutoff value of 10×10^{-1.7}, and the number of NG was counted for the case with a magnetic head with single-layer first cooling layer, the case with a magnetic head with double-layered first cooling layers, and the case without a first cooling layer. The obtained energization test results are shown in Table 1.

TABLE 1

| | First cooling layer | BER NG |
|---|---|---|
| Example 1 | Single | 5/50 |
| | Double | 4/50 |
| Comparative | None | 15/50 |
| example 1 | | |

In the table, BER NG indicates the number of NGs in the magnetic disk devices and the total number of devices. For example, 5/50 indicates that there were 5 NGs out of 50 magnetic disk devices.

Disassembling and analyzing the NG magnetic disk devices revealed that many BER NGs were generated in the magnetic heads due to longer write times and higher loads on the write assist elements.

The results show that the use of the magnetic head in the embodiment extends the life of the assisted recording head on average and suppresses oxidation and other degradation of the recording head within a certain time period.

Furthermore, it is considered that the oxidation suppression effect of the head is achieved because of the effective cooling of the main poles by the first cooling layer.

### Example 2

Preparation of Magnetic Disk Device Using Magnetic Head with Single-Layer First Cooling Layer

A magnetic head with single-layer first cooling layer was obtained in the same way as in Example 1, except that a non-magnetic conductive layer made of Cu was formed on the one first cooling layer instead of the magnetic flux control layer, and a magnetic disk device with a magnetic head with single-layer first cooling layer with the same structure as in FIG. 13 was prepared.

Similarly, multiple magnetic heads with single-layer first cooling layer were fabricated and incorporated into a magnetic disk device with 18 magnetic heads and 9 magnetic disks, for a total of 50 magnetic disk devices with single-layer first cooling layers of Example 2.

In the above magnetic head, as in the magnetic disk device using the magnetic head with single-layer first cooling layer in Example 1, the Peltier coefficient at the interface between the main pole and the first cooling layer is π_{MP}>π₁. Therefore, when the current flows sequentially in the direction of the trailing shield, flux control layer, and main pole, heat absorption occurs at the interface between the main pole and the first cooling layer.

Preparation of Magnetic Disk Device Using Magnetic Head with Double-Layered First Cooling Layer

A magnetic disk device with the same structure as that of FIG. 14 was prepared such that, instead of the magnetic head with single-layer first cooling layer, a magnetic head with a double-layered first cooling layer consisting of 2 nm of CuNi alloy in the first layer and 2 nm of Ru in the second layer was utilized. A total of 50 magnetic disk devices were prepared using magnetic heads with a double-layer first cooling layer whose length in the track width direction is longer than the length in the track width direction of the main poles.

In this magnetic head, the Peltier coefficients at the interface between the main pole and the first cooling layer are π_{MP}>π₁ and π₁<π₂. Therefore, when a current flows from the trailing shield through the magnetic flux control layer, to the main pole, heat absorption occurs at the interface between the main pole and the first cooling layer and heat dissipation occurs at the interface between the first and second layers.

### Preparation of Magnetic Disk of Comparative Example 2

Furthermore, a magnetic disk device of comparative example 2 with the same structure as the magnetic disk device with the magnetic head with a single-layer first cooling layer was prepared except that the first cooling layer was not prepared. A total of 50 magnetic disk devices with the above structure were prepared.

As in Example 1, a long-time energization test was conducted, and the results of the energization test are shown in Table 2 below.

TABLE 2

| | First cooling layer | BER NG |
|---|---|---|
| Example 2 | Single | 3/50 |
| | Double | 3/50 |
| Comparative | None | 9/50 |
| example 2 | | |

In the table, BER NG indicates the number of NGs and the total number of the magnetic disk devices.

Disassembling and analyzing the NG magnetic disk devices revealed that many BER NGs were generated in the magnetic head due to longer write times and higher loads on the write assist elements.

As in Table 2, it was found that the inclusion of the first cooling layer had an effect of suppressing head oxidation even in the assisted recording head configured as in FIG. 11.

It is also considered that the oxidation suppression effect of the head is achieved because of the effective cooling of the main poles by the first cooling layer.

### Example 3

Preparation of Magnetic Disk Device Using Magnetic Head with Single-Layer First and Second Cooling Layers

After forming AlOx side shields, when preparing the main pole by plating, 5 nm of NiCu (layer 1) was first formed as the second cooling layer, followed by the main poles.

Then, as in Example 1, a magnetic flux control layer with single-layer first cooling layer, first conductive layer, adjustment layer, and second conductive layer was created on the main pole, and NiFe was formed as a trailing shield.

Then, after depositing approximately 1 nm of Si underlayer on the second cooling layer in the ABS side, main pole, first cooling layer, magnetic flux control layer, trailing shield, and insulating film by sputtering, a 1.6 nm protective layer is formed by depositing diamond-like carbon on the Si underlayer by CVD method. As a result, a magnetic head having the same structure as in FIG. 18, with singe-layer first cooling layer and single-layer second cooling layer whose length in the track width direction is longer than the length in the track width direction of the main pole, was obtained.

Similarly, multiple magnetic heads were fabricated and incorporated into a magnetic disk device with 18 magnetic heads and 9 magnetic disks, for a total of 50 magnetic disk devices.

In the above magnetic head, the Peltier coefficient at the interface between the main pole and the first and second cooling layers is π_{MP}>π₁. Therefore, when the current flows sequentially in the direction of the trailing shield, flux control layer, and main pole, heat absorption occurs at the interface between the main pole and the first cooling layer and the interface between the main pole and the second cooling layer.

Preparation of Magnetic Disk Device Using Magnetic Head with Double-Layered First and Second Cooling Layers

A magnetic disk device with the same structure as that of FIG. 19 was prepared such that, instead of the magnetic head with single-layer first cooling layer, a magnetic head with a double-layered first cooling layer consisting of 2 nm of CuNi alloy in the first layer and 2 nm of Ru in the second layer was utilized. A total of 50 magnetic disk devices were prepared using magnetic heads with a double-layer first cooling layer whose length in the track width direction is longer than the length in the track width direction of the main poles.

In this magnetic head, the Peltier coefficients at the interface between the main pole and the first cooling layer are π_{MP}>π₁ and π₁<π₂. Therefore, when a current flows from the trailing shield through the magnetic flux control layer, to the main pole, heat absorption occurs at the interface between the main pole and the first cooling layer and heat dissipation occurs at the interface between the first and second layers.

### Preparation of Magnetic Disk of Comparative Example 3

Furthermore, a magnetic disk device of comparative example 3 with the same structure as the magnetic disk device with the magnetic head with a single-layer first cooling layer was prepared except that the first cooling layer was not prepared. A total of 50 magnetic disk devices with the above structure were prepared.

As in Example 1, a long-time energization test was conducted, and the results of the energization test are shown in Table 3 below.

TABLE 3

| | First cooling layer | BER NG |
|---|---|---|
| Example 3 | Single | 5/50 |
| | Double | 3/50 |
| Comparative | None | 12/50 |
| example 3 | | |

In the table, BER NG indicates the number of NGs and the total number of the magnetic disk devices.

Disassembling and analyzing the NG magnetic disk devices revealed that many BER NGs were generated in the magnetic head due to longer write times and higher loads on the write assist elements.

As above, a sufficient effect of suppressing head oxidation was found even in the assisted recording head with the second cooling layer.

Furthermore, it is considered that the oxidation suppression effect of the head is achieved because of the effective cooling of the main poles by the first and second cooling layers.

According to another embodiment, a magnetic head includes a main pole which applies a recording magnetic field to a magnetic recording medium,
an auxiliary magnetic pole arranged with the main pole with a write gap therebetween, forming a magnetic circuit together with the main pole, and
a multi-layer provided between the main pole and the auxiliary magnetic pole, by which electric conductivity is enabled from the main pole to the auxiliary magnetic pole, wherein
the multi-layer includes a first layer and a first conductive layer provided orderly on a surface of the main pole opposed to the auxiliary magnetic pole,
the first layer has a length in a track width direction longer than a length of the main pole in a tracks width direction.

The first layer can have electric conductivity.

The first layer can have heat conductivity.

The first layer can have an effect to cool the main pole.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A magnetic head comprising:
a main pole configured to apply a recording magnetic field to a magnetic recording medium;
an auxiliary magnetic pole provided with the main pole with a write gap therebetween, forming a magnetic circuit with the main pole;
a multi-layer provided between the main pole and the auxiliary magnetic pole, by which electric conductivity is enabled from the main pole to the auxiliary magnetic pole, and including a first cooling layer and a first conductive layer, orderly provided on a surface of the main pole opposed to the auxiliary magnetic pole, and
a second cooling layer on a side surface of a tip of the main pole, wherein
the first cooling layer cools the main pole by Peltier effect when electric current is applied, and a length thereof in a track width is longer than a length in a track width of the main pole.

2. The magnetic head of claim 1, wherein the first conductive layer is a write assist element.

3. The magnetic head of claim 2, wherein the write assist element is a non-magnetic conductive layer.

4. The magnetic head of claim 1, wherein the first cooling layer contains aluminum, chromium, copper, iridium, manganese, molybdenum, nickel, palladium, platinum, ruthenium, silicon, tantalum, tungsten, or zinc.

5. The magnetic head of claim 3, wherein the non-magnetic conductive layer contains aluminum, chromium, copper, iridium, molybdenum, nickel, palladium, platinum, ruthenium, silicon, tantalum, or tungsten.

6. The magnetic head of claim 2, wherein the write assist element is a magnetic flux control layer.

7. (canceled)

8. The magnetic head of claim 1, wherein the first cooling layer is a conductive body with a composition different from that of the main pole, and
where Peltier coefficient of the main pole is π_{MP}, and Peltier coefficient of the first cooling layer is π₁, if a direction of conduction is from the auxiliary magnetic pole, to the first cooling layer, and to the main pole, π_{MP}>π₁, and if the direction of conduction is from the main pole, to the first cooling layer, to the auxiliary magnetic pole, π_{MP}<π₁.

9. The magnetic head of claim 1, wherein the first cooling layer is a multi-layer with two or more layers where layers are counted as a first layer, second layer, . . . , and x layer from the closest layer to the main pole, and where Peltier coefficient of the main pole is π_{MP}, and Peltier coefficients of first to x layers are π₁, π₂, . . . and πₓ, if a direction of conduction is from the auxiliary magnetic pole, to the first cooling layer, and to the main pole, π_{MP}>π₁, and πₓ₋₁<πₓ, and if the direction of conduction is from the main pole, to the first cooling layer, to the auxiliary magnetic pole, π_{MP}<π₁, and πₓ₋₁>πₓ.

10. The magnetic head of claim 1, wherein the first cooling layer has a cross-sectional area perpendicular to the direction of conduction which is greater than a cross-sectional area of the main pole perpendicular to the direction of conduction.

11. (canceled)

12. A magnetic recording/reproducing device with a magnetic head, the magnetic head comprising:
a main pole configured to apply a recording magnetic field to a magnetic recording medium;
an auxiliary magnetic pole provided with the main pole with a write gap therebetween, forming a magnetic circuit with the main pole;
a multi-layer provided between the main pole and the auxiliary magnetic pole, by which electric conductivity is enabled from the main pole to the auxiliary magnetic pole, and including a first cooling layer and a first conductive layer, orderly provided on a surface of the main pole opposed to the auxiliary magnetic pole, and
a second cooling layer on a side surface of a tip of the main pole, wherein
the first cooling layer cools the main pole by Peltier effect when electric current is applied, and a length thereof in a track width is longer than a length in a track width of the main pole.

13. The magnetic recording/reproducing device of claim 12, wherein the first conductive layer is a write assist element.

14. The magnetic recording/reproducing device of claim 13, wherein the write assist element is a non-magnetic conductive layer.

15. The magnetic recording/reproducing device of claim 12, wherein the first cooling layer contains aluminum, chromium, copper, iridium, manganese, molybdenum, nickel, palladium, platinum, ruthenium, silicon, tantalum, tungsten, or zinc.

16. The magnetic recording/reproducing device of claim 14, wherein the non-magnetic conductive layer contains aluminum, chromium, copper, iridium, molybdenum, nickel, palladium, platinum, ruthenium, silicon, tantalum, or tungsten.

17. The magnetic recording/reproducing device of claim 13, wherein the write assist element is a magnetic flux control layer.

18. (canceled)

19. The magnetic recording/reproducing device of claim 12, wherein the first cooling layer is a conductive body with a composition different from that of the main pole, and
where Peltier coefficient of the main pole is π_{MP}, and Peltier coefficient of the first cooling layer is π₁, if a direction of conduction is from the auxiliary magnetic pole, to the first cooling layer, and to the main pole, π_{MP}>π₁, and if the direction of conduction is from the main pole, to the first cooling layer, to the auxiliary magnetic pole, π_{MP}<π₁.

20. The magnetic recording/reproducing device of claim 12, wherein the first cooling layer is a multi-layer with two or more layers where layers are counted as a first layer, second layer, . . . , and x layer from the closest layer to the main pole, and where Peltier coefficient of the main pole is π_{MP}, and Peltier coefficients of first to x layers are π₁, π₂, . . . and πₓ, if a direction of conduction is from the auxiliary magnetic pole, to the first cooling layer, and to the main pole, π_{MP}>π₁, and πₓ₋₁<πₓ, and if the direction of conduction is from the main pole, to the first cooling layer, to the auxiliary magnetic pole, π_{MP}<π₁, and πₓ₋₁>πₓ.

21. The magnetic recording/reproducing device of claim 12, wherein the first cooling layer has a cross-sectional area perpendicular to the direction of conduction which is greater than a cross-sectional area of the main pole perpendicular to the direction of conduction.

22. (canceled)

23. The magnetic head of claim 1, wherein the second cooling layer contains aluminum, chromium, copper, iridium, manganese, molybdenum, nickel, palladium, platinum, ruthenium, silicon, tantalum, tungsten, or zinc.

24. The magnetic recording/reproducing device of claim 12, wherein the second cooling layer contains aluminum, chromium, copper, iridium, manganese, molybdenum, nickel, palladium, platinum, ruthenium, silicon, tantalum, tungsten, or zinc.
